(19) United States
(12) Patent Application Publication
(10) Pub. No.: US 2011/0295619 A1
(43) Pub. Date: Dec. 1, 2011

(54) SYSTEM FOR MANAGING PATIENT ASSESSMENT

(75) Inventor: Mark Tough, Maroubra (AU)

(73) Assignee: FRED BERGMAN HEALTHCARE PTY LTD, North Sydney (AU)

(21) Appl. No.: 13/115,490

(22) Filed: May 25, 2011

Related U.S. Application Data
(60) Provisional application No. 61/347,845, filed on May 25, 2010.
(60) Provisional application No. 61/412,808, filed on Nov. 12, 2010.

(51) Int. Cl. G06Q 50/00

(52) U.S. Cl. 705/3

(57) ABSTRACT

The present invention relates to systems for collecting patient data and for analysing the data for the purpose of managing patient assessment procedures. In particular, the invention relates to a system for using collected patient data for the purpose of prioritising patients for assessment by clinicians. In particular, the invention provides a system for analyzing patient data in an automated system for managing patient assessment. The system includes a database for storing patient assessment data collected from a plurality of patients, a computer processor executing instructions stored in a computer program and a data processing computer program executed by the computer processor. The program comprises instructions for identifying one or more patients who have one or more predetermined care requirements wherein the predetermined care requirement optionally comprises one or more of: further assessment, a predetermined medical or surgical intervention, a funding-related requirement, an incontinence-related requirement, and/or supply of a healthcare product. The present invention also provides a computer program comprising instructions for optionally allocating a value to a patient based on patient assessment data, optionally comparing the allocated patient value with a limit value and identifying one or more patients who are candidates for further assessment optionally according to a proximity of the allocated patient value to a limit of one or more predetermined value ranges containing the patient value.

### FIELD OF THE INVENTION

The present invention relates to systems for collecting patient data and for analysing the data for the purpose of managing patient assessment procedures. In particular, the invention relates to a system for using collected patient data for the purpose of prioritising patients for assessment by clinicians.

### BACKGROUND OF THE INVENTION

Healthcare service providers operate in a heavily regulated environment in which aspects such as funding and reimbursement are based on systems requiring assessment and reporting of data regarding the extent of care required for each patient in a number of categories of patient care. Accordingly, the profitability of the healthcare service provider is dependent upon accurate assessment of the extent of care required for each patient under the care of the service provider in order to ensure that adequate funding and reimbursement is obtained to cover the cost of providing the care required by the patient. Provision of healthcare services, and paradigms for funding those services, vary from country to country.

In the area of aged care regulatory frameworks exist wherein funding and reimbursement for aged care facilities is provided on a per patient basis and is determined by the extent of care required for each patient in a number of defined categories of patient care. Accordingly, for the aged care facility to claim funding and reimbursement from the regulator and/or the aged care funding provider the aged care facility must assess each patient on the basis of the extent of care required in each of the categories of care. Typically, this is achieved by clinicians and/or nurses manually completing a checklist, questionnaire or the like to determine the level of care required by the patient in a plurality of categories or areas of care (e.g. feeding, toileting, mobility, cognitive ability etc). The clinician then manually determines, based on a set of assessment criteria, a value or score for each patient in each category and optionally, a total score for the patient. The clinician must also manually record the data associated with the patient's assessment from which the score or value for the patient in each of the categories of assessment was derived—either in a paper based or electronic database.

The residential aged care facility (RACF) or provider must then periodically calculate, based on each patient's score or value in each category of diagnosis, the funding or reimbursement that will be provided by the regulator or the funding body based on an applicable funding model. Some existing funding models provide funding on the basis of calculating a total score or value from a number of scores or values in a plurality of categories of diagnosis and comparing the total score or value against a set of value or score ranges. The quantum of funding or reimbursement provided to the aged care provider or aged care facility is provided on the basis of comparing the scores or values for each patient against the value ranges provided by the funding model.

The United States of America has mandated Interai assessment protocols however the marketplace in the US is more fragmented. There is a combination of user pays, some Medicare/government funds and private health insurance. More than 50 million Americans carry private health insurance, specifically for the provision of care when they are ageing, requiring care either at home or in a RACF. The insurers require a formal assessment to be done before funding is provided. Certain benchmarking in relation to disabilities has a direct affect on the disgorgement of funds for the management of their incontinence.

In each scenario described above, financial viability of RACF or provider is linked to accurate assessment of the patients in the sense that funding quanta are allocated according to the level of care deemed necessary for individuals, after they have been assessed. For example, it is not financially sustainable to provide, a level of care to one or more patients that is greater (and so more expensive to provide) than the level of care that is justified by the assessment and hence funded or reimbursed based on the assessment data for that patient obtained from an out of date or inaccurate assessment of the patient's diagnosis. This is particularly critical where the funding model of the funding institution is provided to the aged care facility or provider on a stepped or threshold basis. In these models where patient assessment data based on diagnosis of the patient results in a value that is just below a certain threshold the care provider may be entitled to a substantially lower quantum of funding or reimbursement than if the value just exceeds the threshold in which case the care provider may be entitled to a substantially higher quantum of funding or reimbursement. Of course regular assessment of patients for funding evaluation is, itself, time consuming and costly and as such, should not be undertaken without justification

The discussion of the background to the invention included herein including reference to documents, acts, materials, devices, articles and the like is intended to explain the context of the present invention. This is not to be taken as an admission or a suggestion that any of the material referred to was published, known or part of the common general knowledge as at the priority date of any of the claims.

### SUMMARY OF THE INVENTION

In one form of the invention, there is provided a system for analyzing patient data in an automated system for managing patient assessment, the system including:

a database for storing patient assessment data collected from a plurality of patients;

a computer processor executing instructions stored in a computer program;

a data processing computer program executed by the computer processor, the program comprising instructions for

identifying one or more patients who have one or more predetermined care requirements

wherein the predetermined care requirement optionally comprises one or more of: further assessment, a predetermined medical or surgical intervention, a funding-related requirement, an incontinence-related requirement, and/or supply of a healthcare product.

In some embodiments, of the invention, identification of the one or more patients who have one or more predetermined care requirements optionally comprises one or more of

allocating a value to a patient based on the patient assessment data,

comparing the allocated patient value with a limit value, and/or

assessing proximity of the allocated patient value to a limit of one or more predetermined value ranges containing a patient value.

In some embodiments, the invention comprises a program which comprises instructions for prioritizing a plurality of patients who are candidates for further assessment based on the proximity ranking of their respective allocated patient value to a limit of one or more predetermined value ranges containing the patient value.

In some embodiments, patient assessment data is grouped into a plurality of patient assessment categories, and the allocated patient value for each patient is calculated as a sum of sub-values for each of the assessment categories in the group.

In some embodiments, each patient assessment category group includes respectively one of the one or more predetermined value ranges and patients are prioritized based on proximity of the allocated value for each group to the corresponding limit of the one or more predetermined value ranges for the group.

In some embodiments, patients with a patient value in closest proximity to an upper limit of one of the value ranges containing the patient value are highest priority candidates for further assessment.

In some embodiments, the value ranges are consecutive.

Some embodiments further comprise the step of calculating a probability that one of the values for a patient will exceed a limit of at least one of the value ranges.

In some embodiments, the patients are prioritized in order of the probability that at least one of the values will exceed a limit of at least one of the value ranges.

In some embodiments, the probability that a patient value will exceed a limit of at least one of the value ranges is determined by gap analysis.

In some embodiments, each of the value ranges corresponds to a quantum of funding for one of the categories of patient assessment.

In some embodiments, the patient assessment data is data that is used to determine a quantum of funding for one of the categories of patient assessment.

In some embodiments, the allocated patient value, the value limit and the value ranges are quantitative.

In some embodiments, the allocated patient value, the value limit and the value ranges are qualitative.

Embodiments of the invention are configurable to operate with one or more benchmarking or other criteria applicable to a funding or care paradigm. The funding or care paradigm may be based on one or more factors. These factors may be selected, for example, from the group including: geographical location (e.g. country or region, state, county or the like), funding source (e.g. government or private); funding instrument (e.g. reimbursement or other) and patient age to name a few. The invention may also be configurable to manage assessments in other realms such as education, entertainment an the like.

In another form of the invention, there is provided a computer program comprising instructions for

optionally allocating a value to a patient based on patient assessment data,

optionally comparing the allocated patient value with a limit value and

identifying one or more patients who are candidates for further assessment optionally according to a proximity of the allocated patient value to a limit of one or more predetermined value ranges containing the patient value.

In another form of the invention, there is provided a system for managing an aspect of patient care comprising:

a database for storing patient assessment data;

a computer processor to execute instructions stored in a computer program;

a computer program executable by the computer processor, the program comprising instructions for

optionally allocating a value to a patient based on patient assessment data,

optionally comparing an allocated patient value with a limit value and

identifying one or more patients who are candidates for further assessment.

In another aspect, the invention provides a computer program comprising instructions for identifying one or more patients who are candidates for further assessment according to an allocated patient value.

In another aspect, the invention provides a system for managing an aspect of patient care comprising a computer program, the computer program comprising instructions for identifying one or more patients who are candidates for further assessment according to an allocated patient value.

The aspect of patient care to be managed by systems, methods and computer programs according to embodiments of the present invention may be of any suitable type. For example, it may relate to funding from a government body, patient assessments for one or more purposes, patient care outcomes such as incidence of adverse events, incidence of positive events (such as recovery times) and so on.

Other features and advantages of the invention may be apparent to those skilled in the art upon reviewing the following drawings and description of embodiments of the invention.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components or group thereof.

### BRIEF DESCRIPTION OF THE DRAWINGS

FIGS. 1 (i) and 1 (ii) illustrate a flow chart diagram of a preferred form of the invention including features of a system for analyzing collected patient data, a computer server including a database for storing patient assessment data collected from a plurality of patients; a data processing computer program operating in computer memory for allocating a value for each patient based on the patient assessment data, comparing the allocated values, or a sum of the allocated values, of the patients and prioritizing the patients based on the proximity of their respective allocated value, or sum of allocated values, to a limit of one or more value ranges to determine patients that are candidates for reassessment. FIGS. 1 (i) and 1 (ii) are to be viewed with FIG. 1 (i) vertically above FIG. 1 (ii)

FIGS. 2 (i) to 2 (xiv) illustrate a table, wherein the first pair of FIGS. 2 (i) and 2 (ii) are to be viewed side by side and the next pair of FIGS. 2 (iii) and 2 (iv) are to be viewed side by side and below FIGS. 2 (i) and 2 (ii), and so on for the remaining FIGS. 2 (v) to 2 (xiv). The table illustrated in FIGS. 2 (i) to 2 (xiv) comprises a data output of an embodiment of a system in accordance with the invention wherein the system is configured for a funding model for aged care, the output including a table of patients in an exemplary patient care facility and their respective values, expressed as “Domain Rating”, in 12 different categories of diagnosis.

FIGS. 3 (i) and 3 (ii) illustrate a table wherein FIGS. 3 (i) and 3 (ii) are to be viewed side by side. The table illustrated in FIGS. 3(i) and 3(ii) comprises a data output of the system of FIGS. 2 (i) to 2 (xiv).

FIGS. 4 (i) to 4 (xiv) illustrate a table, wherein the first pair of FIGS. 4 (i) and 4 (ii) are to be viewed side by side and the next pair of FIGS. 4 (iii) and 4 (iv) are to be viewed side by side and below FIGS. 4 (i) and 4 (ii) and so on. FIGS. 4 (i) to 4 (xiv) illustrate a table comprising a data output of the system of FIGS. 2 (i) to 2 (xiv) including, in particular, results of a gap analysis in relation to the diagnoses of the patients.

FIGS. 5 (i) to 5 (xiv) illustrate a table, wherein the first pair of FIGS. 5 (i) and 5 (ii) are to be viewed side by side and the next pair of FIGS. 5 (iii) and 5 (iv) are to be viewed side by side and below FIGS. 5 (i) and 5 (ii) and so on. FIGS. 5 (i) to 5 (xiv) illustrate a table comprising a data output of the system of FIGS. 2 (i) to 2 (xiv) including, in particular, prioritisation of patients for reassessment of their diagnoses.

FIGS. 6 (i) and 6 (ii) illustrate a data output of the system of FIGS. 2 (i) to 2 (xiv) including general statistical data in relation to the outcomes of the gap analysis and the prioritisation of patients for reassessment wherein FIG. 6 (i) is to be viewed vertically above FIGS. 6 (ii).

### DETAILED DESCRIPTION

In many patient care institutions such as hospitals, aged care facilities and the like typically a large number of patients are cared for at any given time. Patients within these facilities typically exhibit a variety of disorders such as diseases, injuries or disabilities or combinations thereof. Such disorders are treated in the facility by various therapies in order to either cure or ameliorate the disorder. Providing such therapies to a patient will typically incur a cost on the part of the facility. Depending on the therapy, the costs associated therewith can vary significantly. Institutions for the care and treatment of patients can derive funding for the care of the patients from a variety of sources. Such sources of funding may include Government sources or private sources such as health insurance institutions.

Funding sources for patient care accessed by patient care providers and institutions often apply a funding model by which funding is allocated to the patient care provider on the basis of the extent of care required for each patient, on a per patient basis. Such funding models are intended to fund adequately the provision of care required by the patient. Accordingly, funding for patient care provided to the patient care provider is, to a large extent, determined by patient data related, in particular, to the diagnosis of the patient's disorders including diseases, injuries, disabilities, and the like. Some funding models operate by categorising patient disorders, determining the extent or severity of the disorders within each of the categories and providing funding to the patient care provider on the basis of the extent and severity of the patient's diagnosis in each of the categories either considered separately or in combination.

One such funding model is the Australian Commonwealth Government Aged Care Funding Instrument (ACFI) which is a resource allocation instrument developed by the Australian Commonwealth Government for the purpose of allocating funding to aged care service providers on the basis of health care needs of patients under the care of the service provider. Systems, methods and computer programs will be described with particular reference to the operation of the aged care funding instrument of the Australian Commonwealth Government. However, it is to be understood that the systems, methods and computer programs of the present invention can have broader application in relation to other purposes in which a system for analysing collected patient data for managing patient assessment would be advantageous and applicable, both in Australia and in other jurisdictions.

The funding model of the Aged Care Funding Instrument involves 12 categories of diagnosis of patient disorders such as disease, injury, disability and the like. These include (1) Nutrition, (2) Mobility, (3) Personal Hygiene, (4) Toileting, (5) Continence, (6) Cognitive skills, (7) Wandering, (8) Verbal behaviour, (9) Physical behaviour, (10) Depression, (11) Medication, and (12) Complex healthcare. The process which must be followed by the aged care facility in meeting the requirements of the funding model is to assess each patient against each of the categories 1 to 12 to assess the extent or severity of the patient's disorders against each of the categories of diagnosis 1 to 12. Based on the extent or severity of the diagnosis of the patient's disorders a rating such as A, B, C or D, with A being the lowest severity and D being the highest severity, is allotted in each category for each patient. Each rating, according to the funding model, is allotted a score or value.

Accordingly, the score or the value is based on the extent or severity of the patient's disorders. The funding model then adds the scores in a plurality of the categories, such as categories 1 to 5, 6 to 10 and 11 to 12, to determine an overall value or score for each of the groups of categories. The overall score for each of the groups of categories for each patient is then compared to a plurality of ranges of scores that the funding model uses to assess the level of funding that will be provided to the patient care provider for each of the groups of categories of diagnosis. The funding model applies three levels of funding, high, medium and low, for each of the groups of categories of patient diagnosis. The value ranges corresponding to the high, medium and low levels of funding in the funding model are consecutive such that the arrangement is stepped, or in other words, applies a series of thresholds, beyond which funding provided by the funding provider to the healthcare provider can vary significantly with only slight incremental changes in the diagnosis or assessment of the extent or severity of the patient's disorders in one or more of the categories.

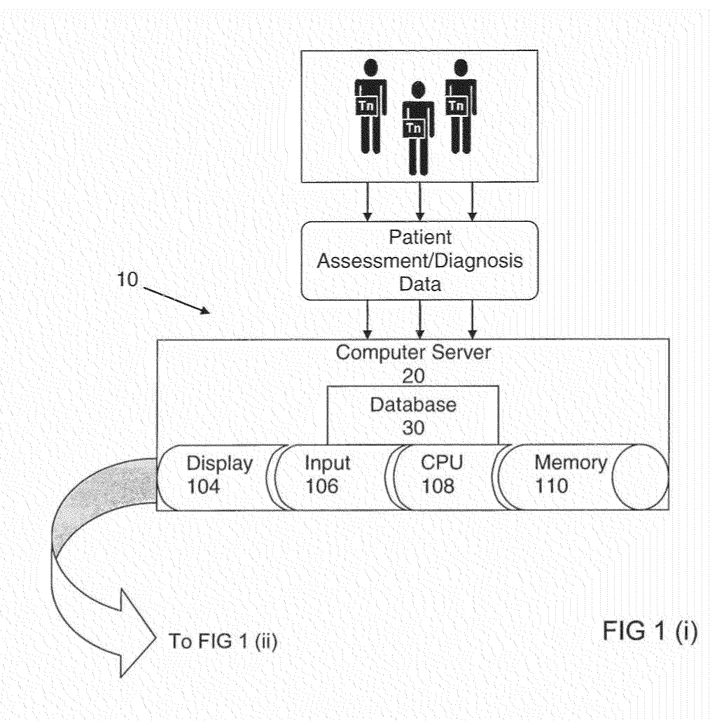

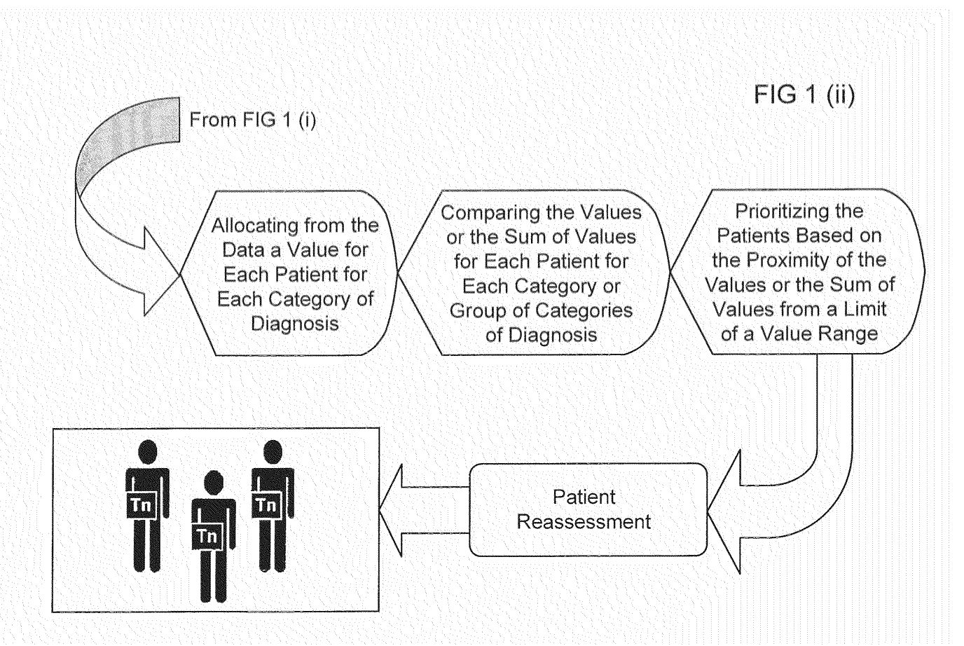

Accordingly, the invention provides, with reference to FIGS. 1 (i) and 1 (ii), a system 10, in an automated system for managing patient assessment, including a computer server 20 including a memory 110, a microprocessor or CPU 108, an input 106 and a display 104. The computer server 20 is configured to provide a database 30 for storing patient assessment/diagnosis data entered into the database via the input 106. The input 106 may include a specific data entry facility for the computer server 20 or may include a means for capturing and uploading patient assessment/diagnosis data from a variety of different electronic medical records, administrative data systems and the like. The database 30 is configured to receive and store patient assessment data collected by clinicians, nurses and the like in a patient care facility. The patient assessment data collected from the patients includes data relating to the extent or severity of the patient's disorders in one or more categories of patient diagnosis, such as the one or more of the categories of patient diagnosis 1 to 12 set out above. The patient assessment data received and stored by the database 30 is allocated a rating which can be expressed in any suitable form. In one form, the patient assessment data is expressed as any one of the ratings A, B, C or D, with A being the least severe and D being the most severe extent of disorder of the patient, in each of the categories of diagnosis.

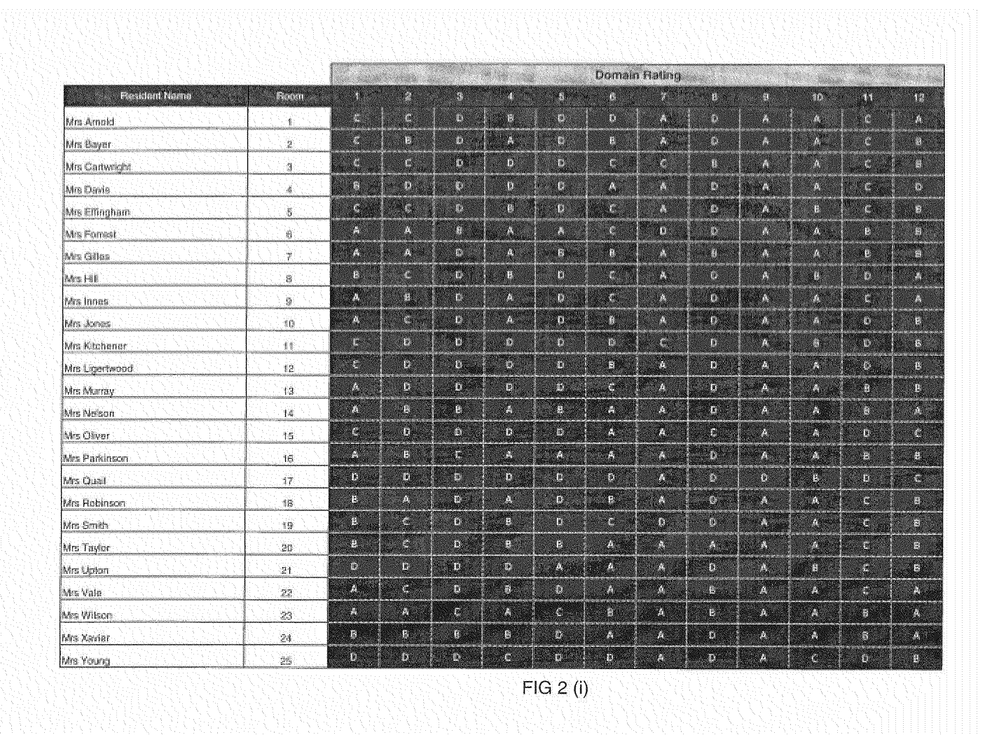

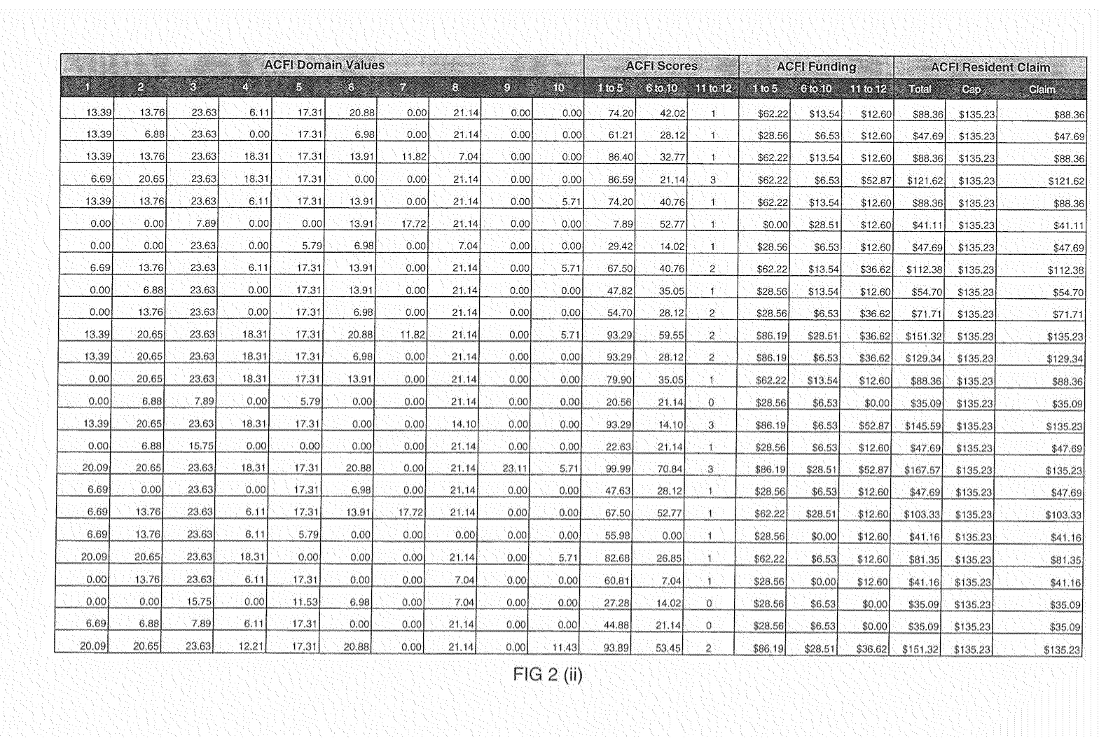

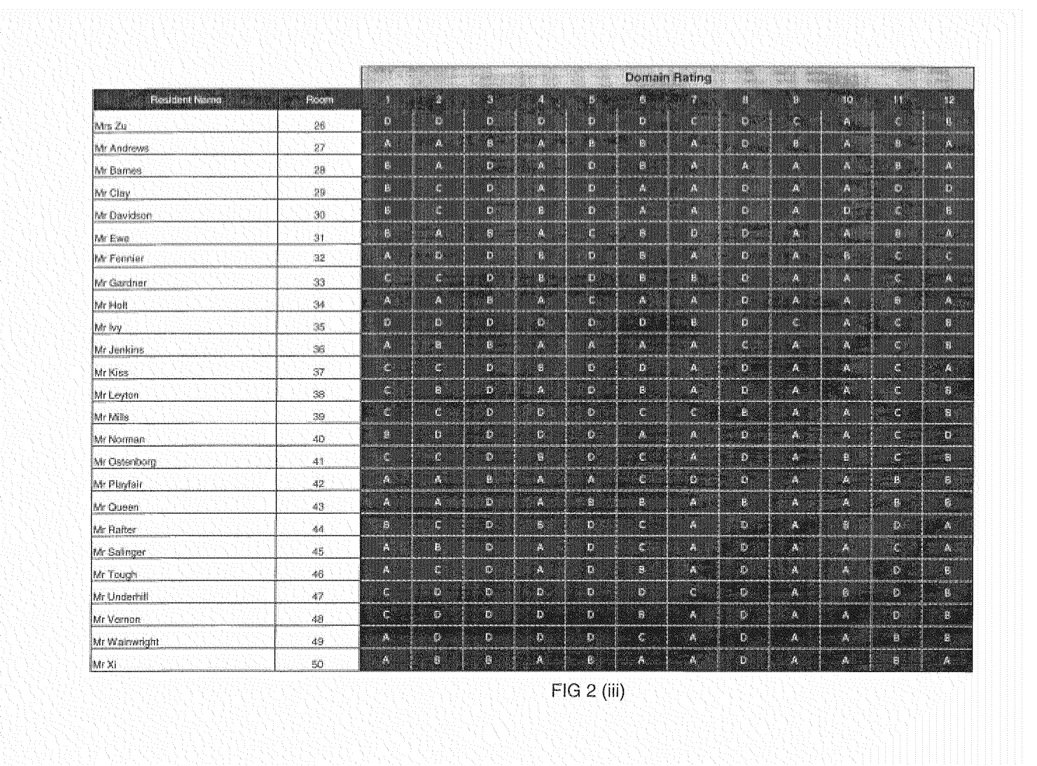

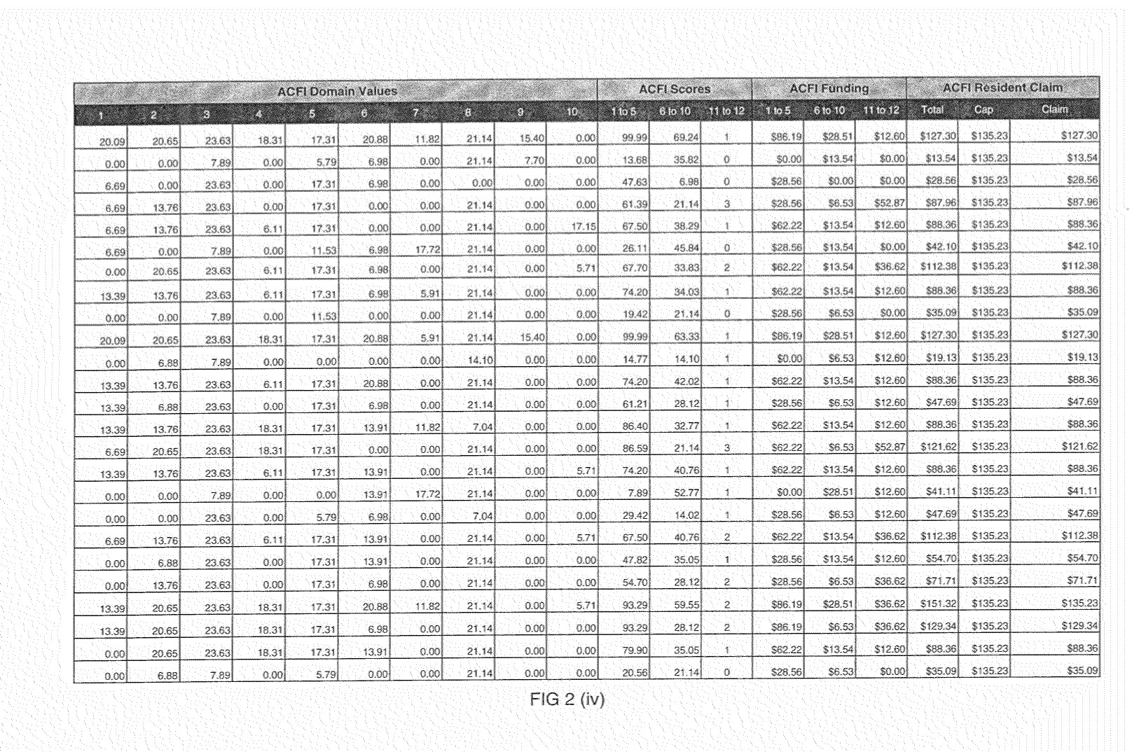

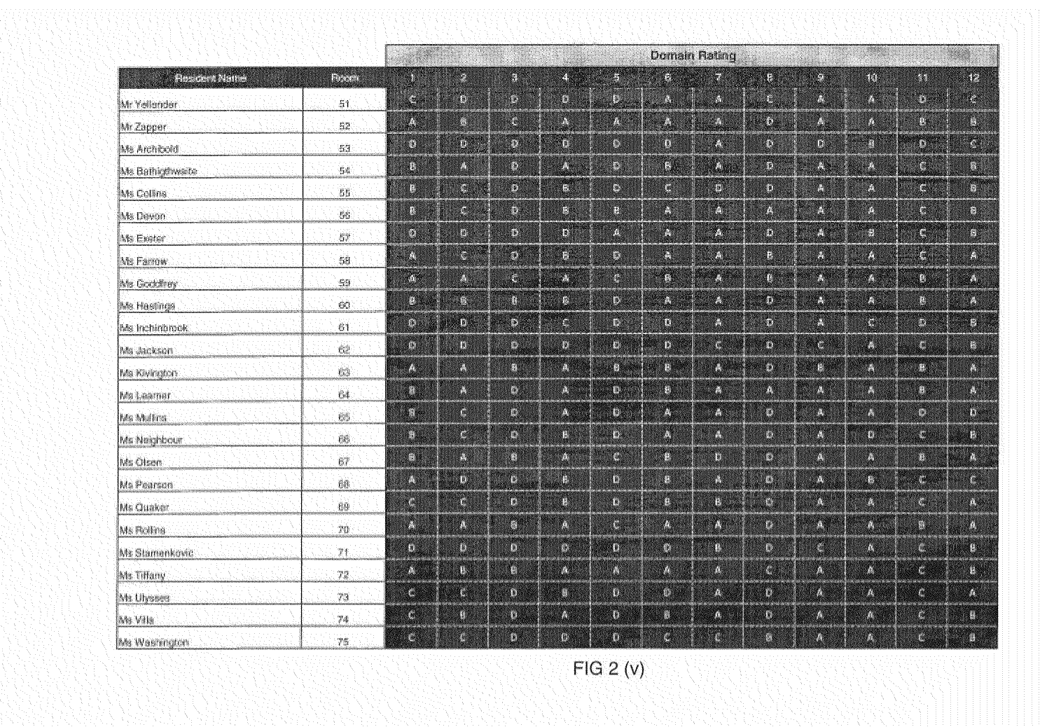

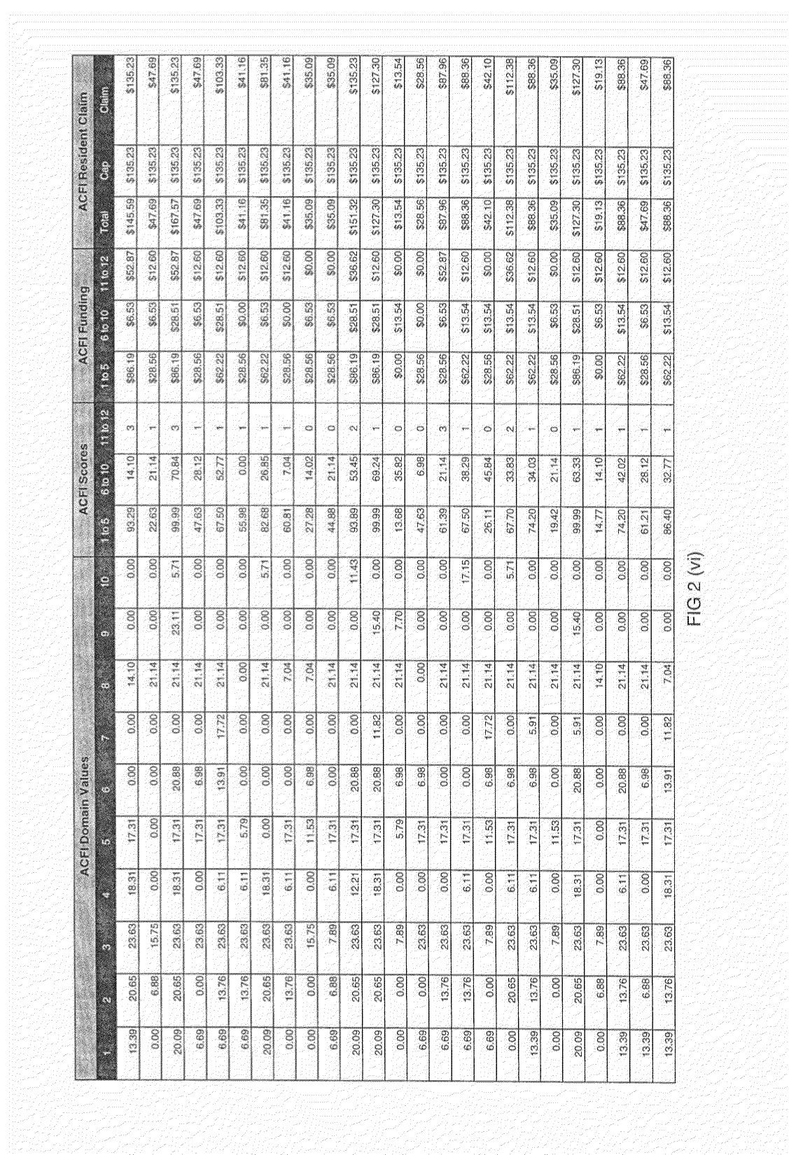

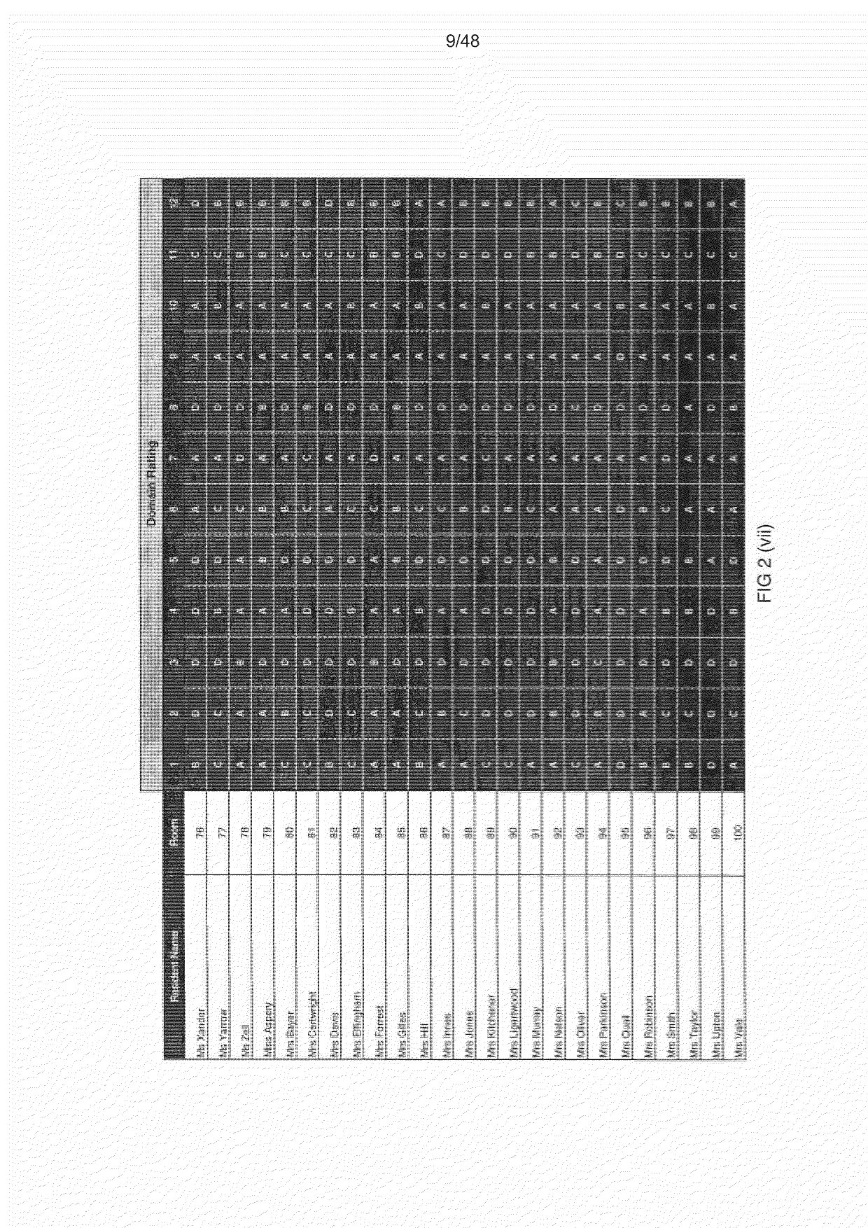

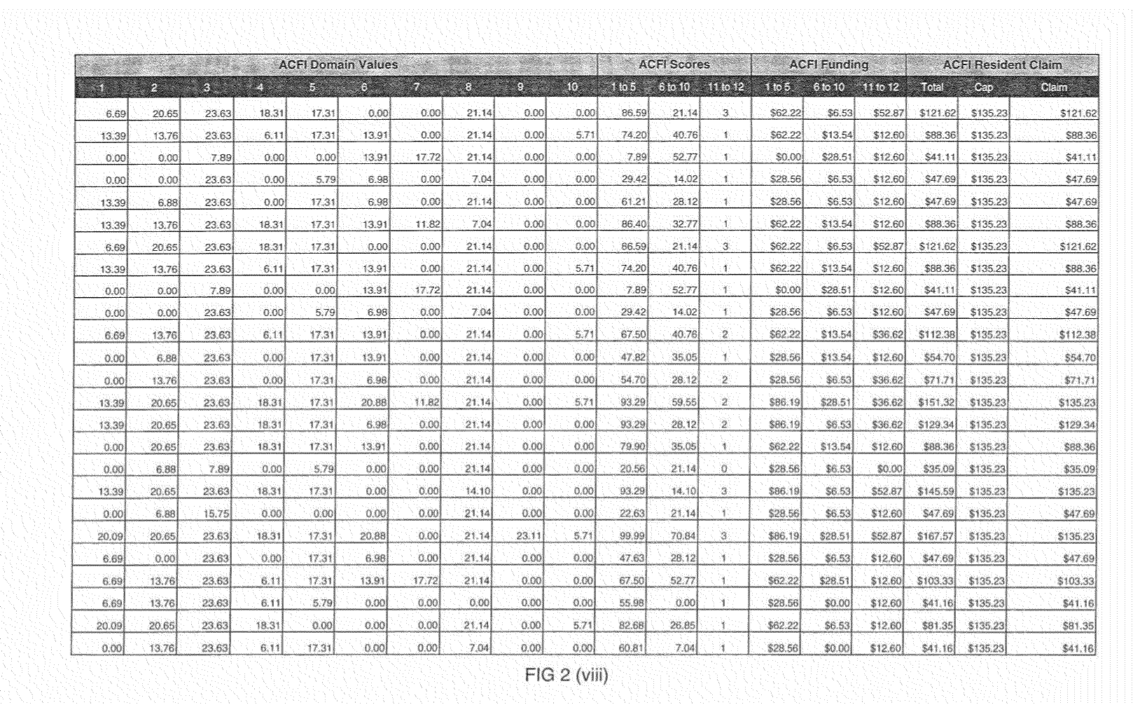

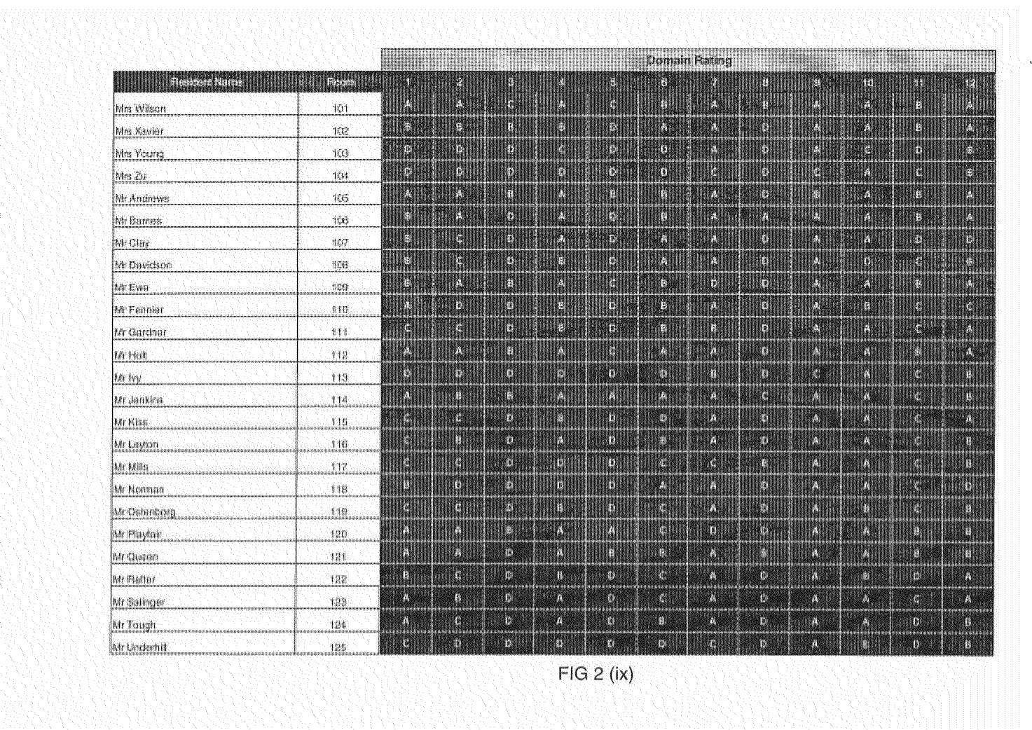

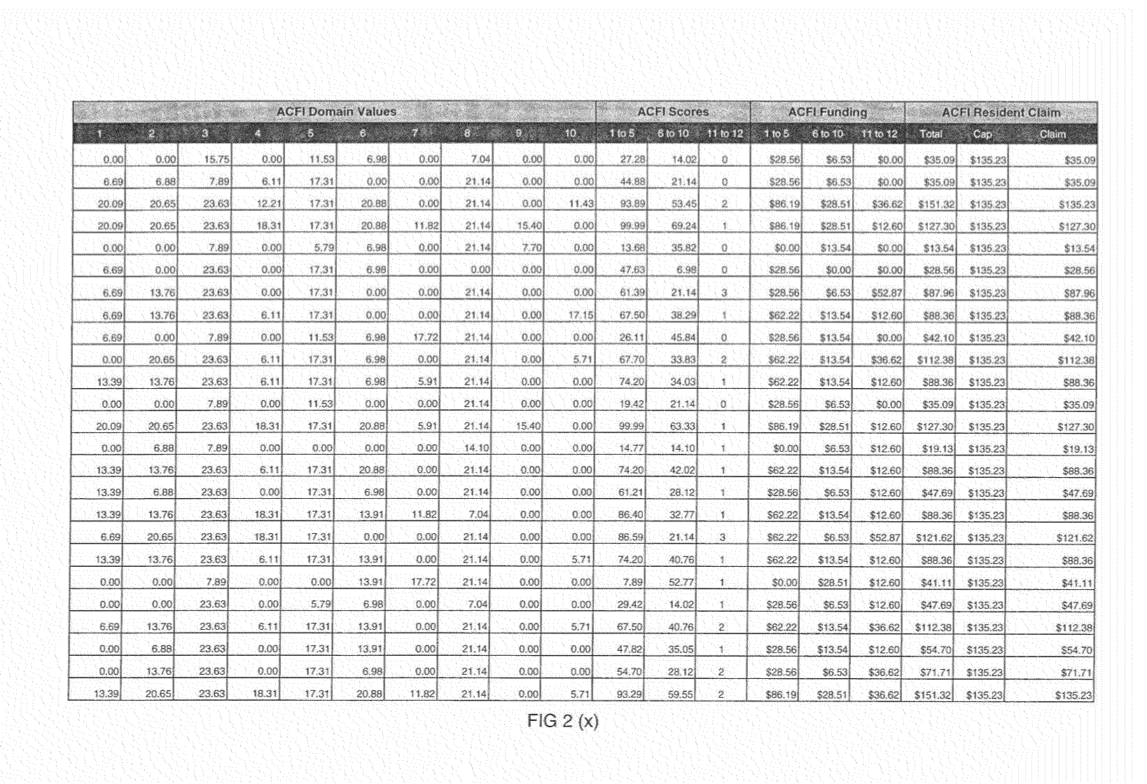

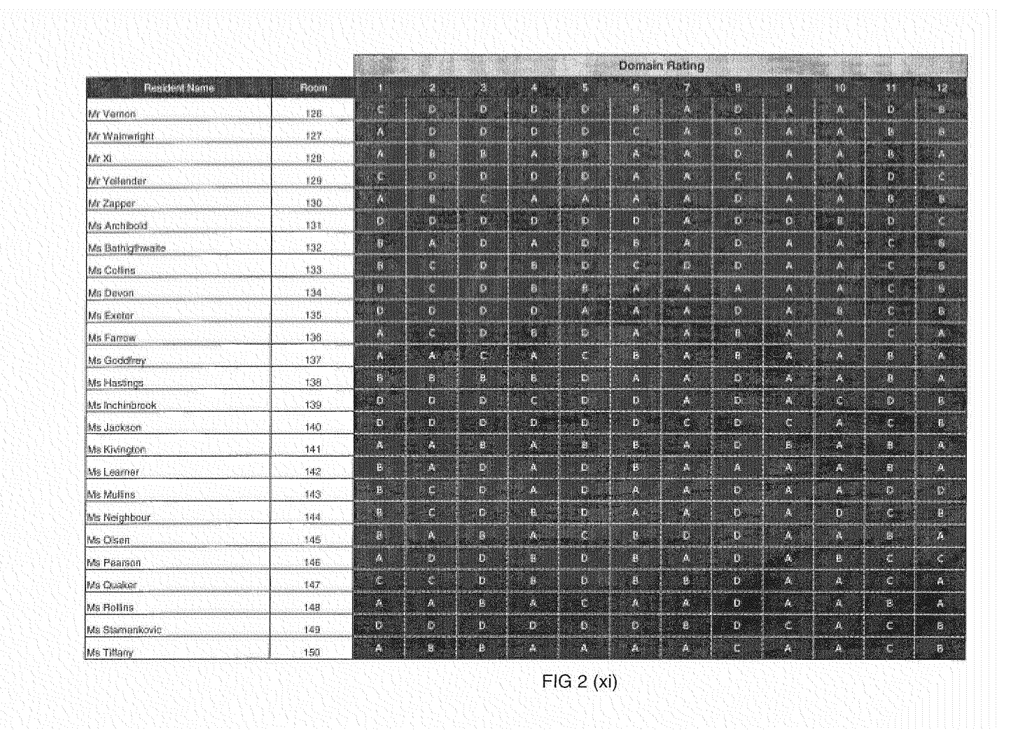

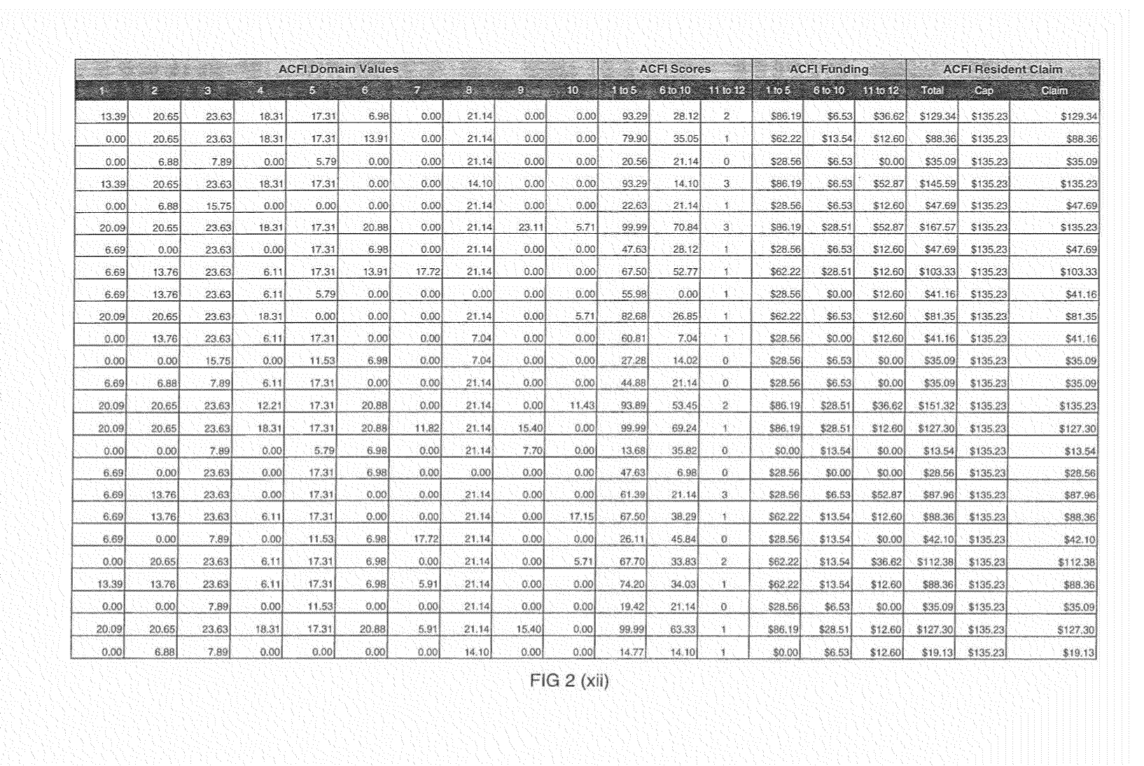

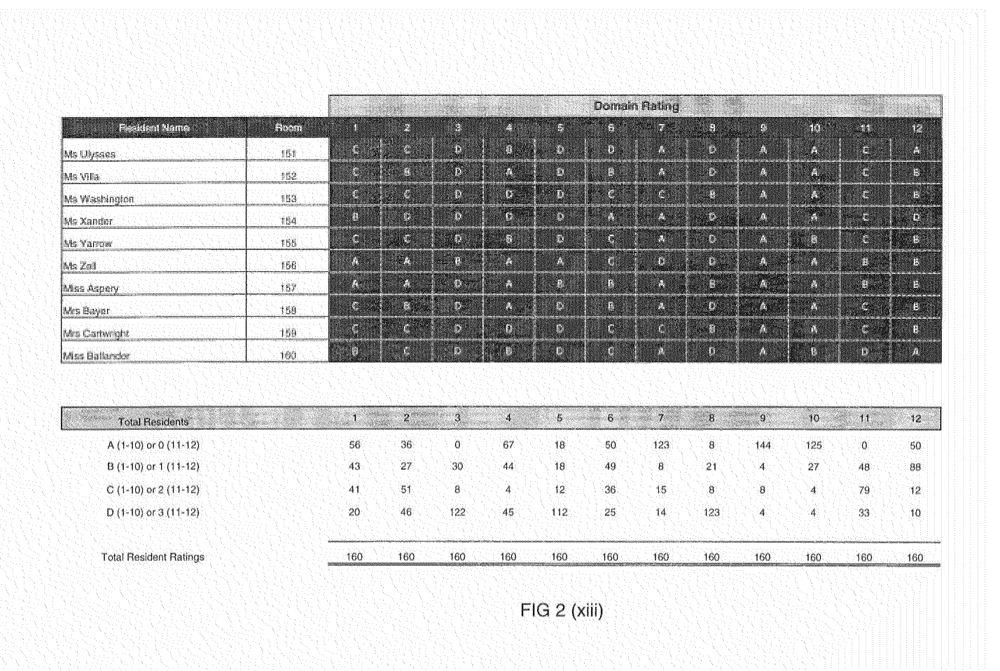

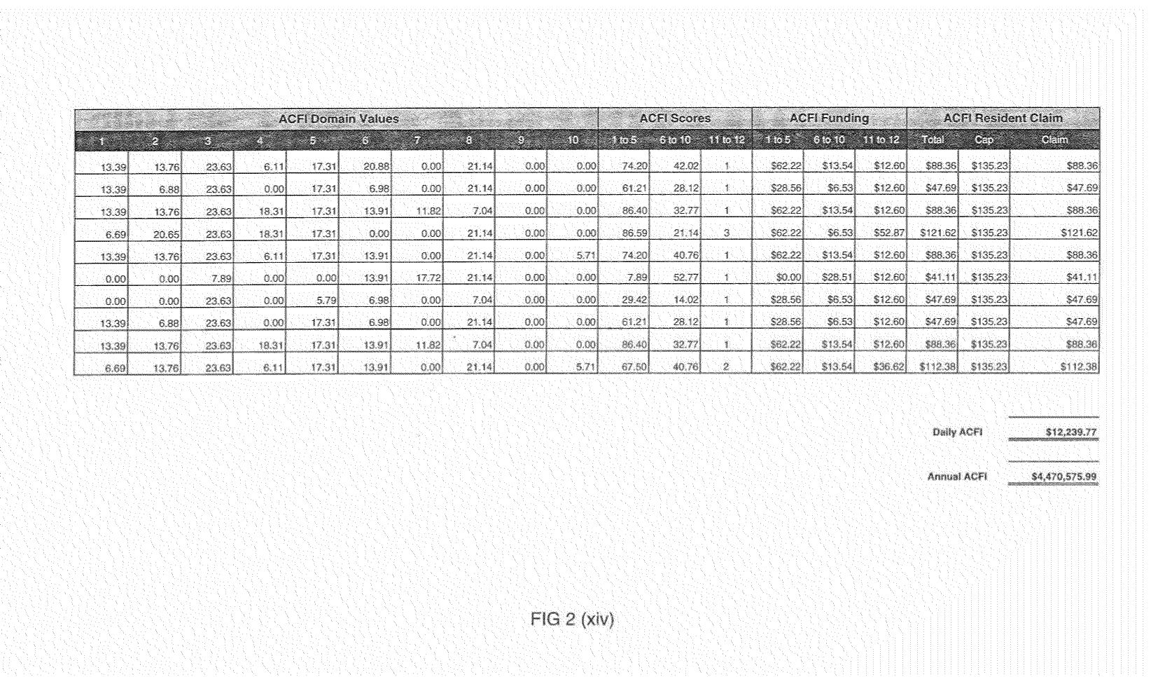

Referring to FIGS. 2 (i) to 2 (xiv), which illustrate a table of patients and their respective value, expressed as “Domain Rating” in categories 1 to 12 of diagnoses, the database receives and stores the patient assessment data, expressed as raw data and as ratings, collected from the plurality of patients.

The system 10 further includes a data processing computer programme operating in the computer memory 110 contained within the computer server 20 which allocates a value, such as a numerical value, for each patient in each category based on the patient assessment data, expressed as any one of the ratings A, B, C, or D, received and stored in the database.

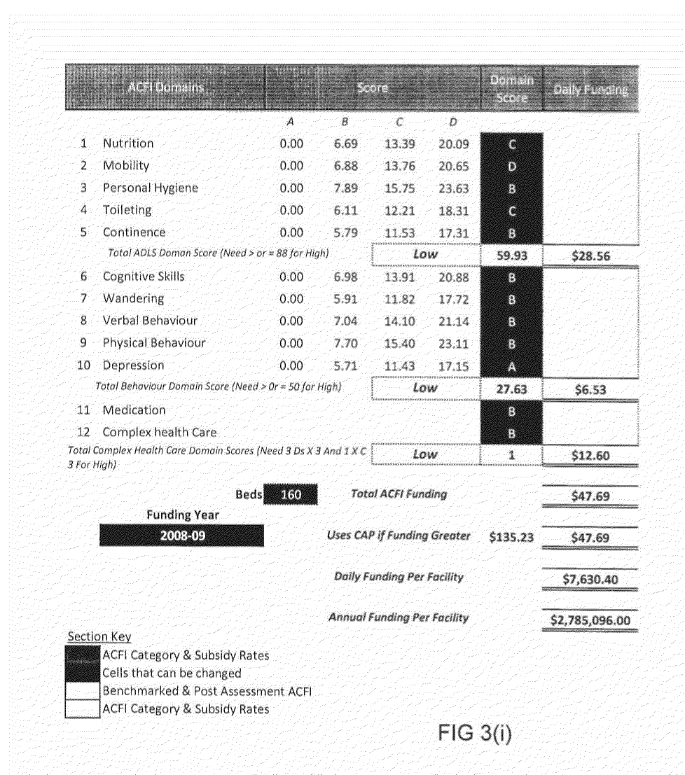

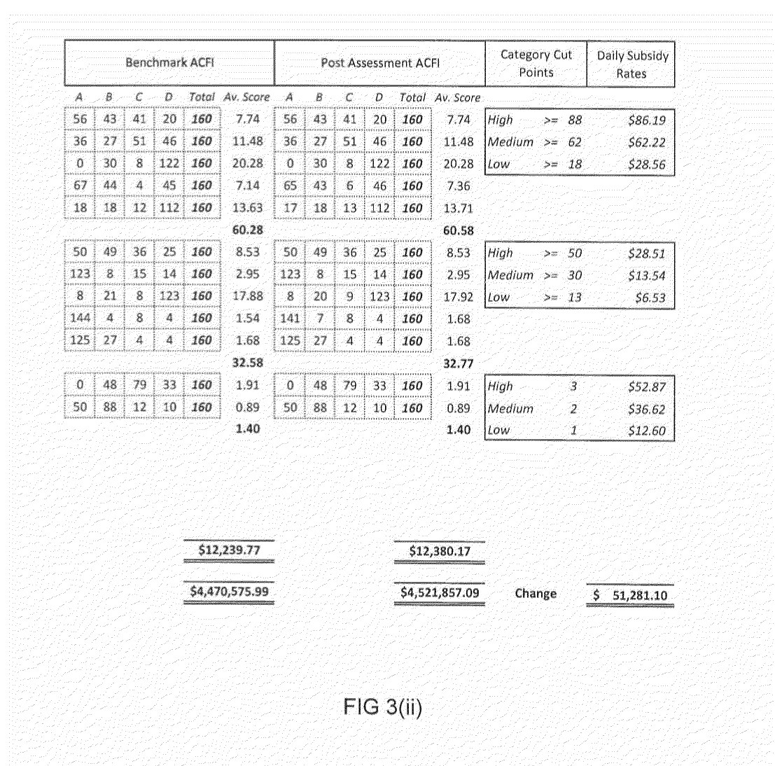

Referring to FIGS. 3 (i) and 3 (ii) which illustrates an exemplary data output of the system 10, configured for the funding model of the Aged Care Funding Instrument of the Australian Commonwealth Government, in which each of the levels of patient assessment data A to D corresponds with a predetermined value or score associated with each category. For example, in the category 5 ‘Continence’ the value or score associated with A is 0, associated with B is 5.79, associated with C is 11.53 and associated with D is 17.31. The data processing computer programme allocates the appropriate value or score associated with the patient assessment data rating A to D determined for the particular patient in each category based on assessment of the diagnosis of the patient. Referring to FIGS. 2 (i) to 2 (xiv), the data processing computer programme allocates the value or score associated with the patient assessment data for each patient in each category of diagnosis as shown in the table headed ‘ACFI Domain Values’ and compares the allocated values or scores of the patients in each category against one another.

After comparing the allocated values of the patients the data processing computer programme then prioritises the patients based on the proximity of their respective allocated value, either in a single category or in a combination of categories, to a limit of one or more pre-determined value ranges containing the value. The value ranges may be predetermined for any factor depending on the purpose of the system 10, however, in the present example each of the one or more predetermined value ranges is associated with a quantum of funding to be allocated by the funding provider to the care provider. For example, as illustrated in FIGS. 3 (i) and 3 (ii), in the exemplary system 10 associated with the exemplary funding model described above, the values or scores in categories 1 to 5 are added to provide a total value such as the scores indicated in the column headed “Domain Score”. Similarly, the values in categories 6 to 10 are added to provide a second total value. Furthermore, the values in categories 11 and 12 are added to provide a third value total. The first value total is provided in the row headed ‘Total ADLS Domain Score’, the second total value is provided in the row headed ‘Total Behaviour Domain Score’ and the third total value is identified by ‘Total Complex Healthcare Domain Scores’.

Each of the first, second and third total values is then compared by the data processing computer programme against three respective value ranges for each of the first, second and third value totals respectively indicated by ‘High’, ‘Medium’ and ‘Low’ under the column headed “Category Cut Points”. Each of the value ranges has at least one limit and, in some cases an upper and lower limit, such as in the case of the Medium value range. The value range into which the first, second and third total values respectively fall determines the funding provided by the funding provider to the care provider in accordance with the funding model as indicated under the column entitled ‘Daily Subsidy Rates’.

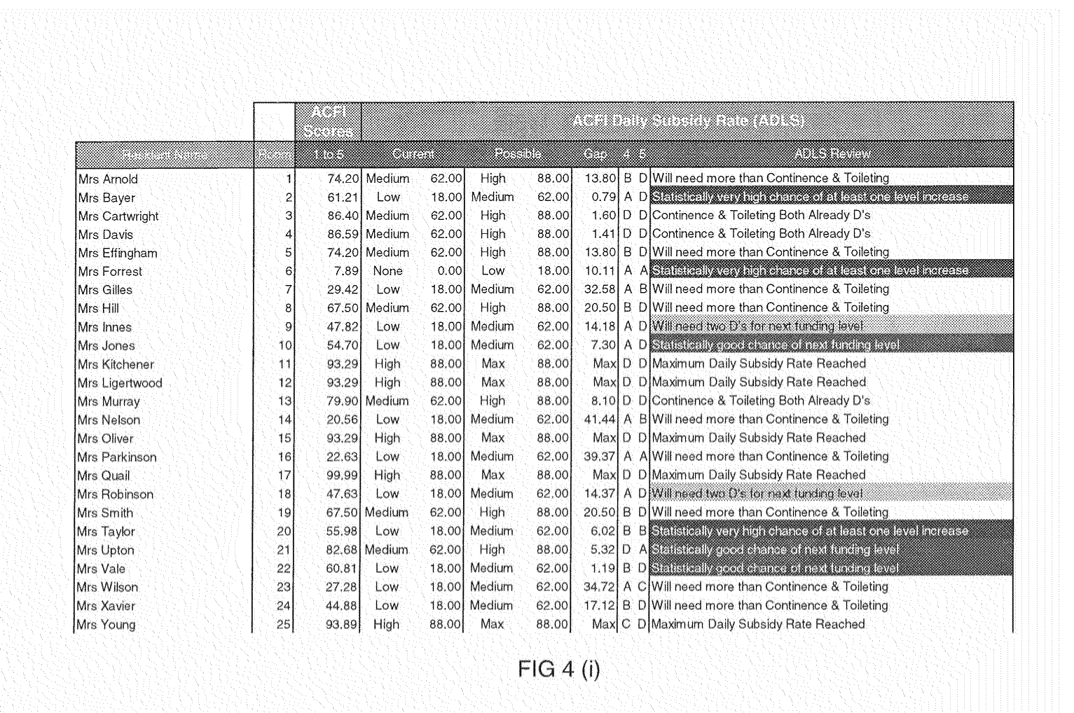

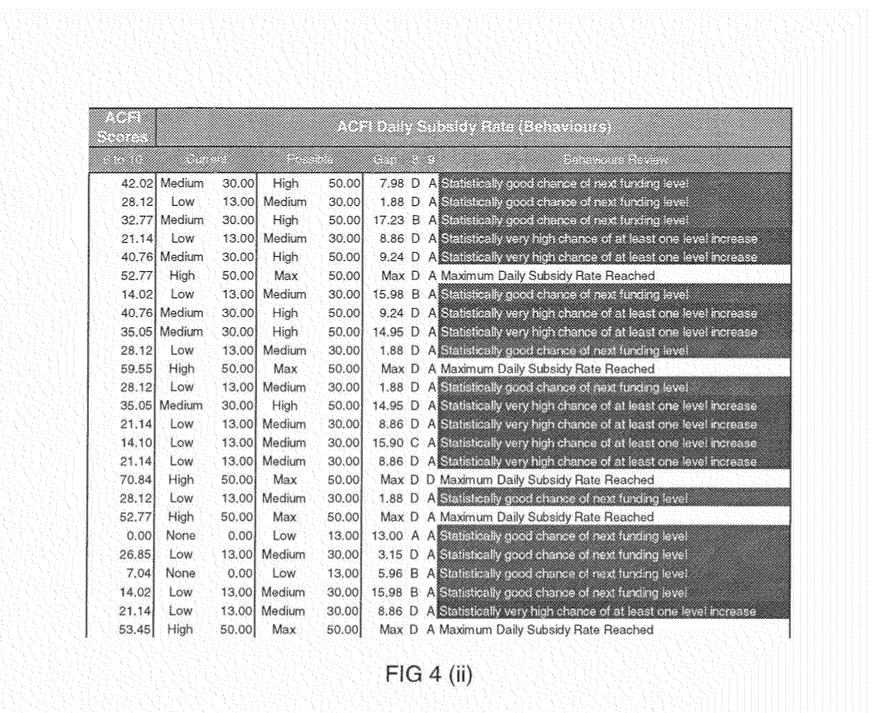

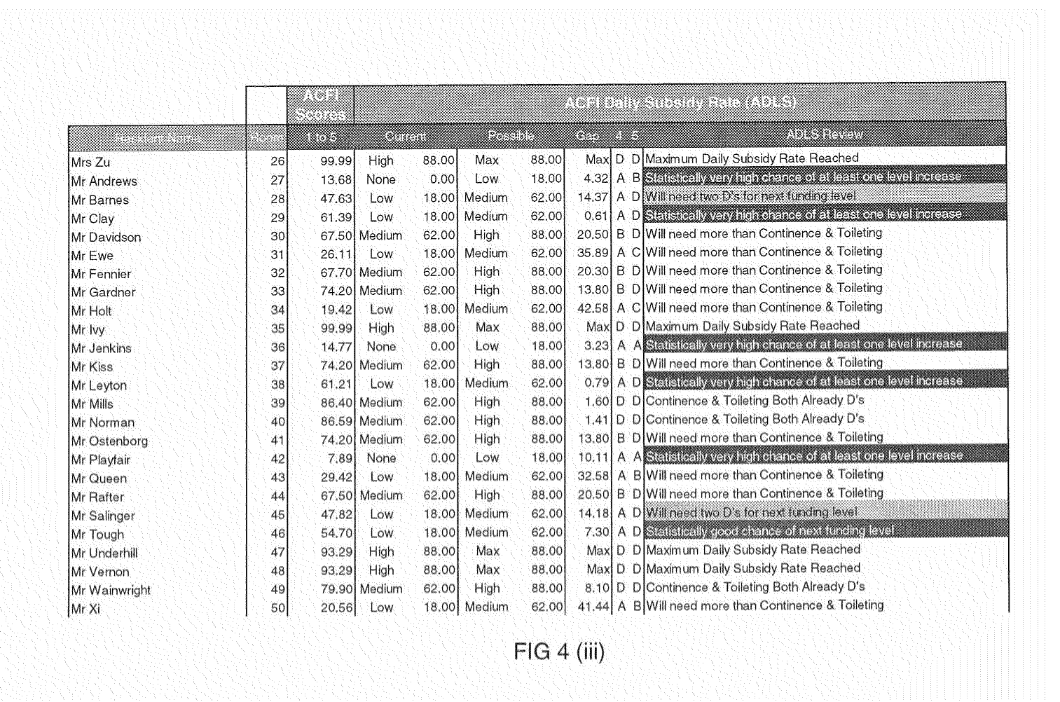

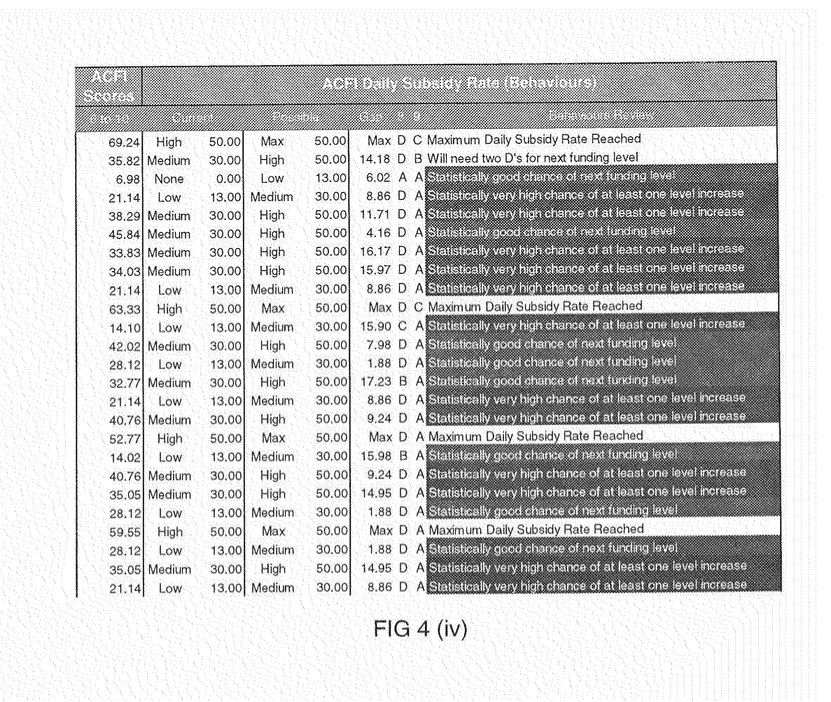

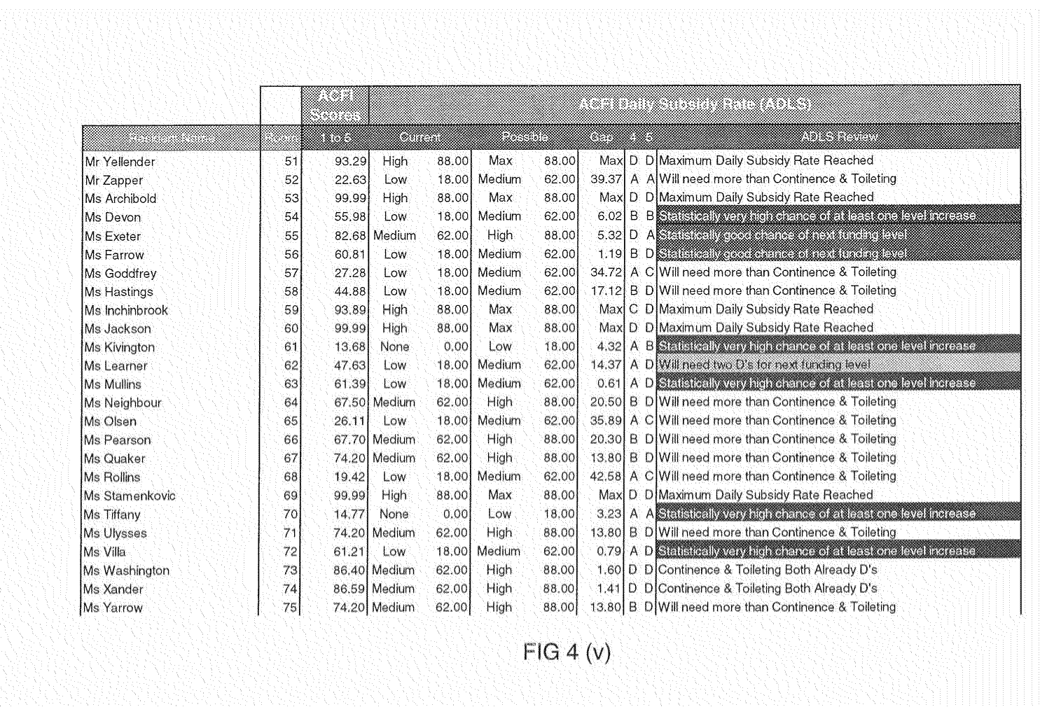

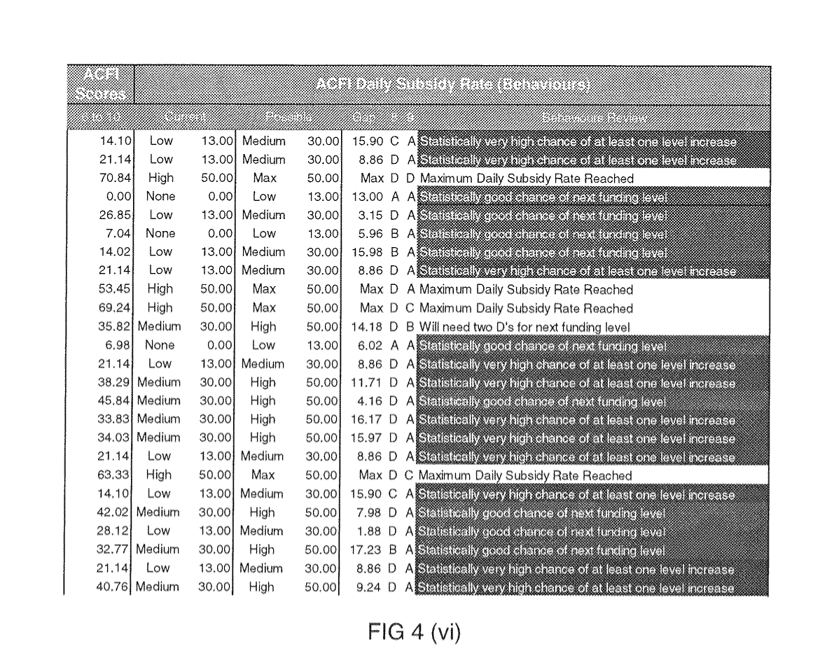

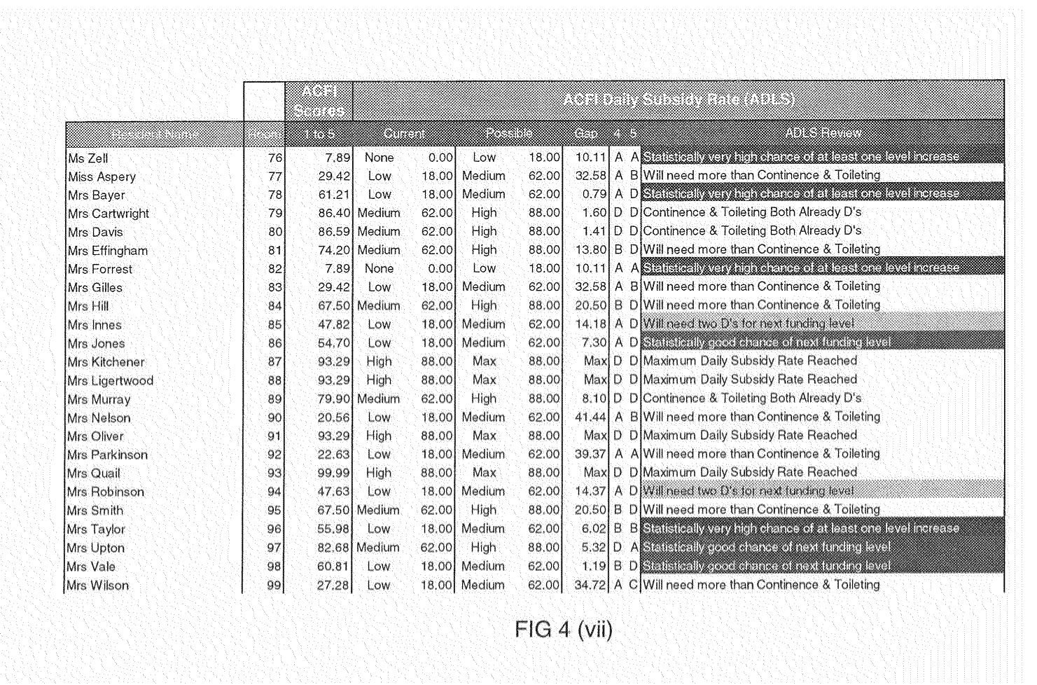

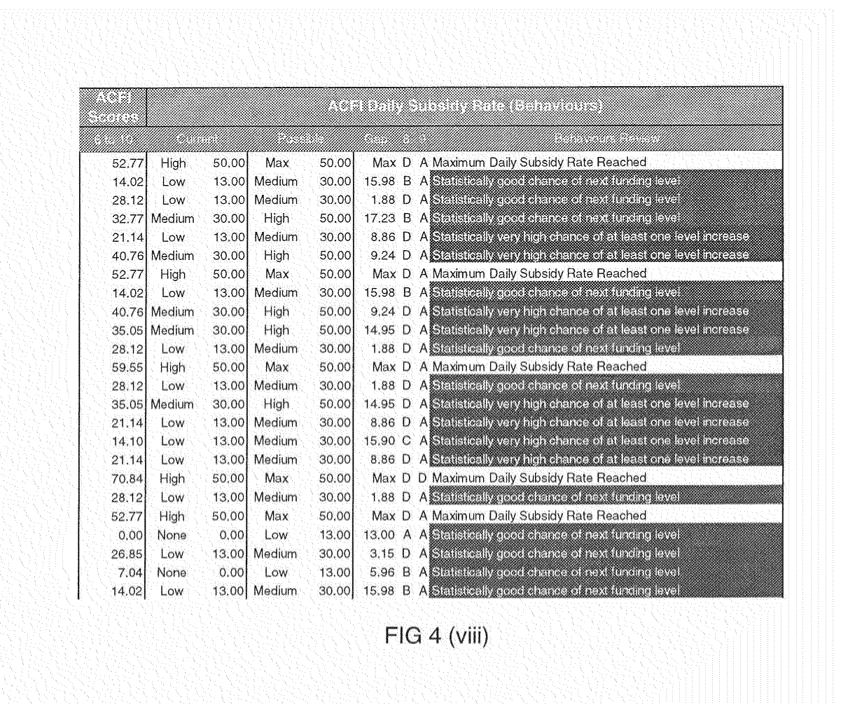

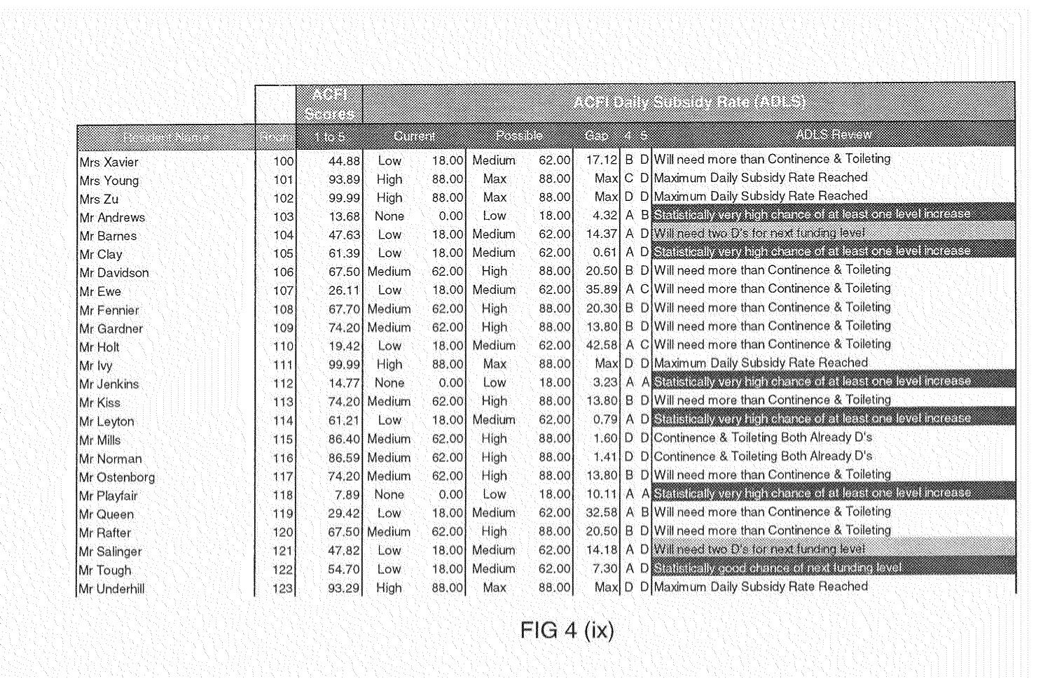

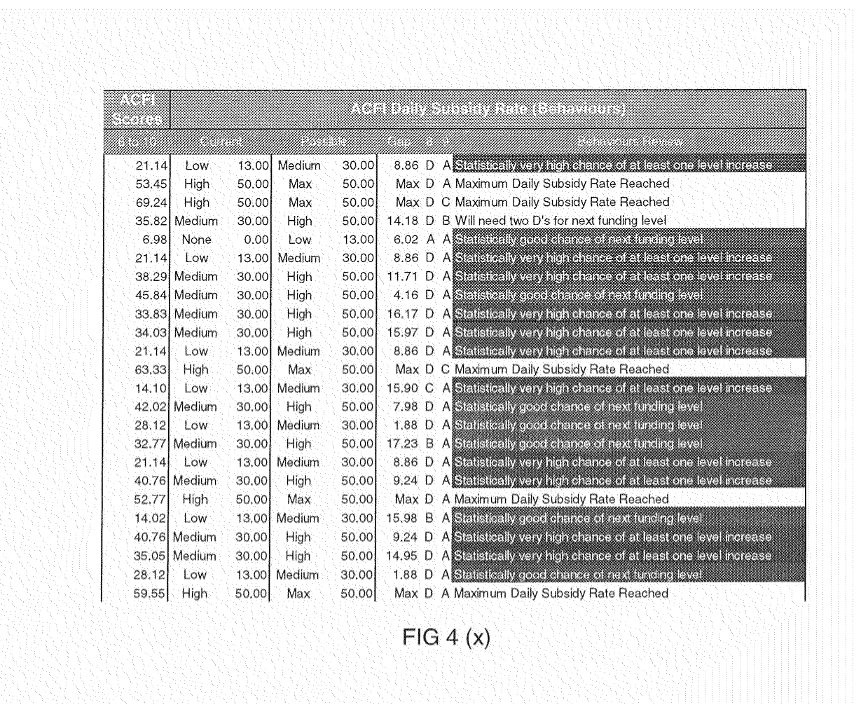

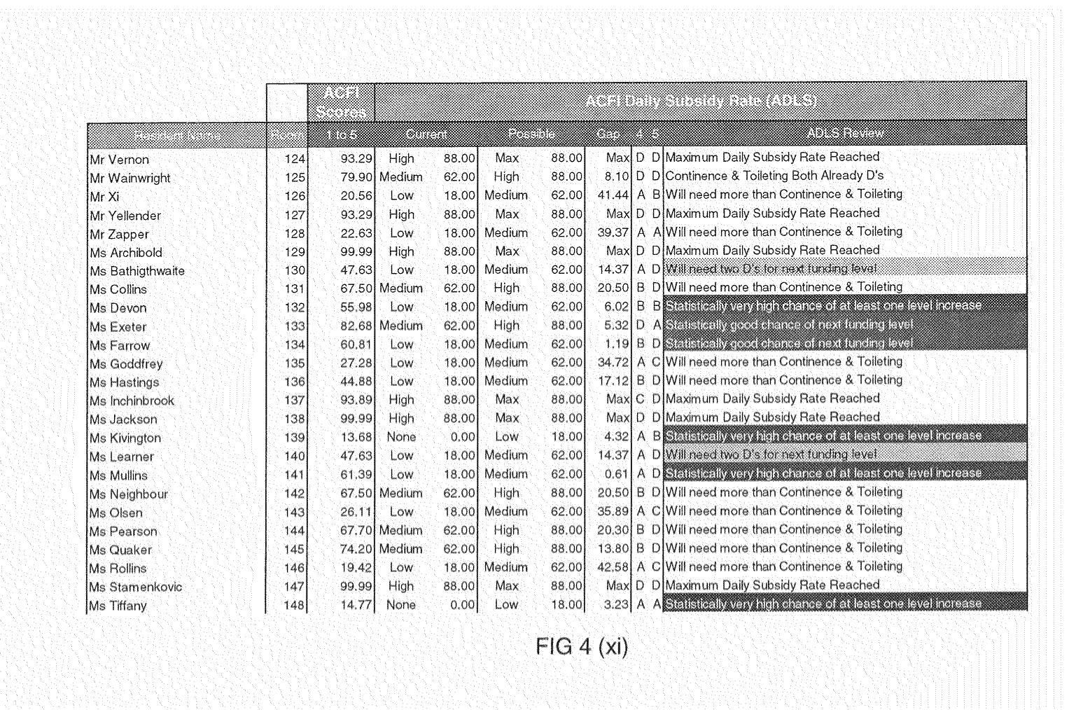

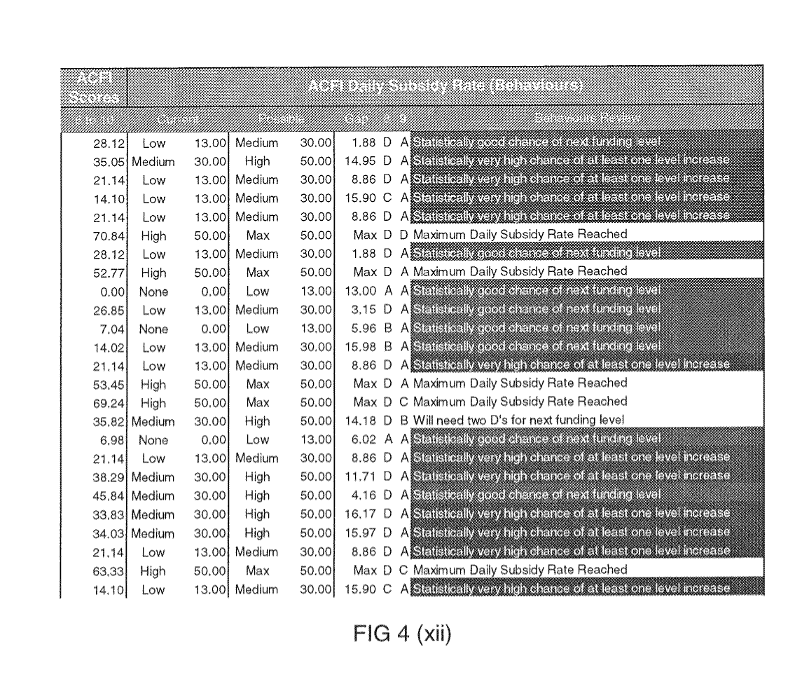

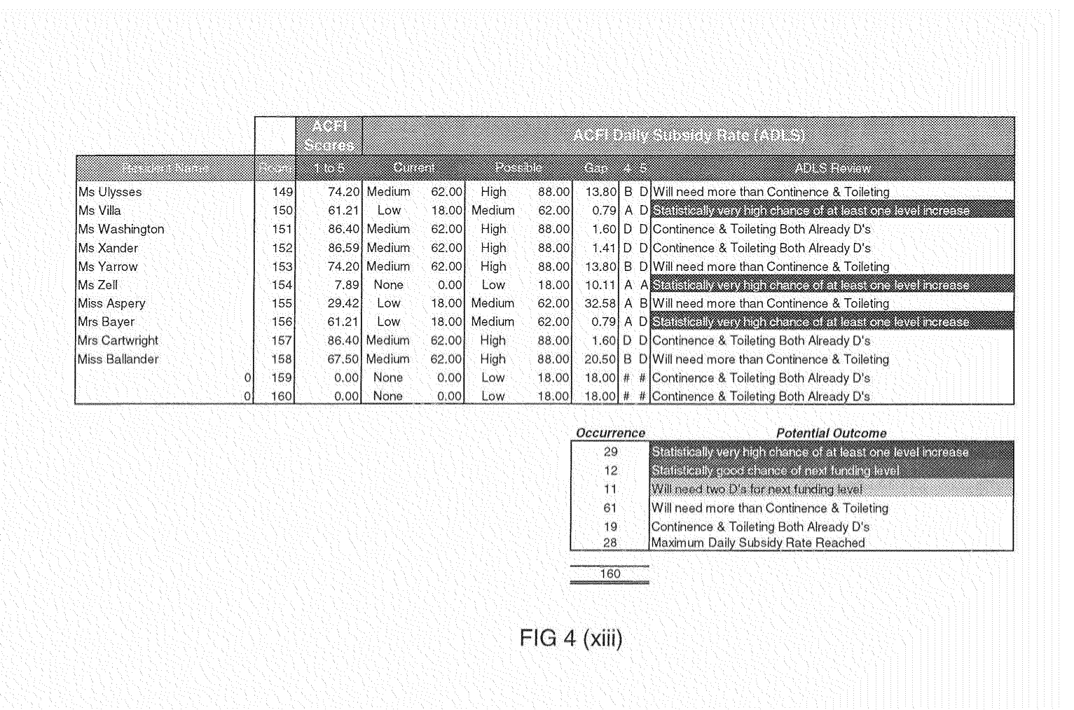

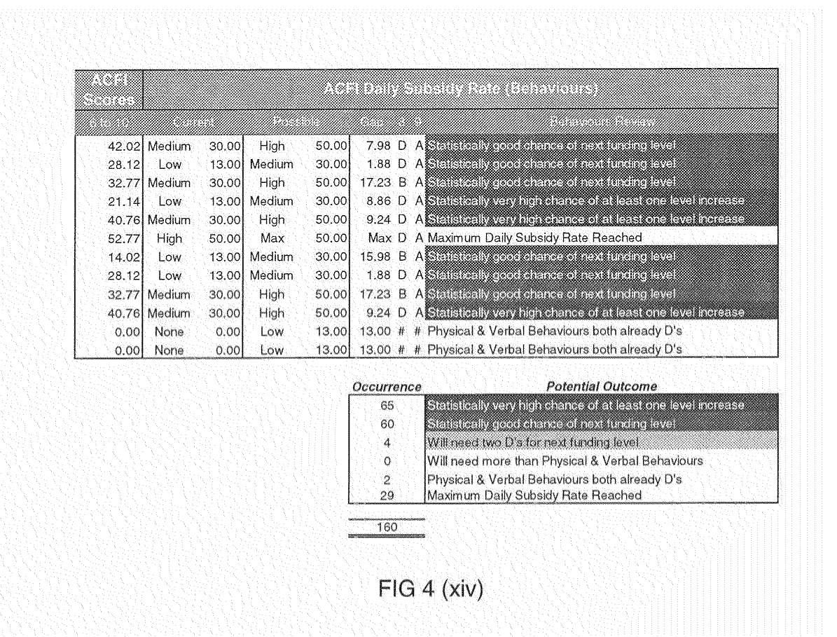

As illustrated in FIGS. 4 (i) to 4 (xiv), the data processing computer programme produces a set of results in respect of each patient in the care of the care provider including the first, second and third total values respectively associated with the 1^{st} to 5^{th}, 6^{th} to 10^{th}, and 11^{th} to 12^{th} categories of diagnosis as well as the associated funding level value range into which the value totals fall. The data processing computer programme also produces an assessment of the ‘gap’ between each of the value totals and an upper limit of the value range containing the value. For example, in row 2, the patient named ‘Mrs Bayer’ in room 2 has a total value in the first to five categories of 61.21 which is a gap of 0.79 from the upper limit of 62.0 of the “Low” funding category in which the value falls. Because the value ranges are consecutive, the score of 61.21 is also has a gap of 0.79 from the lower limit of the next funding category, namely the “Medium” funding category. Accordingly, as can be seen in FIGS. 4 (i) to 4 (xiv), the data processing computer programme applies a gap analysis to the total values of each of the patients in the groups of categories of diagnoses applied by the funding model.

The application of the invention means a reduction in the need for labour to conduct the assessments, validation of prescription and the validation of change of prescription. The system of the invention simplifies the process of assessing and making recommendations to the relevant funding agencies, trusts and the like. The system of the invention simplifies the process of assessing and making recommendations for appropriate funding and patient care.

Funding for aged care in Germany is not dissimilar to funding approaches adopted in Australia. German residents are qualified for funding according to where in the German benchmarking spectrum they sit. The German spectrum provides ratings between 1 and 4 and their policies are funded accordingly.

Embodiments of the system described herein provide a system for simplifying and/or automating the process of assessing and making recommendations for appropriate funding and patient care, and for managing those assessments. As has been demonstrated, the system is applicable in Australia, Germany and a range of other jurisdictions and can be modified to operate within the bounds of different funding schemes such as those employed countries such as Denmark, the United Kingdom, the Netherlands, Sweden, Canada and the United States to name a few.

In the embodiments described above with reference to the accompanying Figures the allocated patient value, the value limit and the value ranges are quantitative. However, it is to be appreciated that the allocated patient value, the value limit and the value ranges can be qualitative or a combination of quantitative and qualitative values. For example, instead of numerical values, such as those described above and illustrated in the figures, values may be expressed in qualitative terms derived from interviews or observations of patients or clinicians. Other qualitative values may be derived from the kind of care being provided to patients in a patient care facility rather than simply the quantity of care being provided.

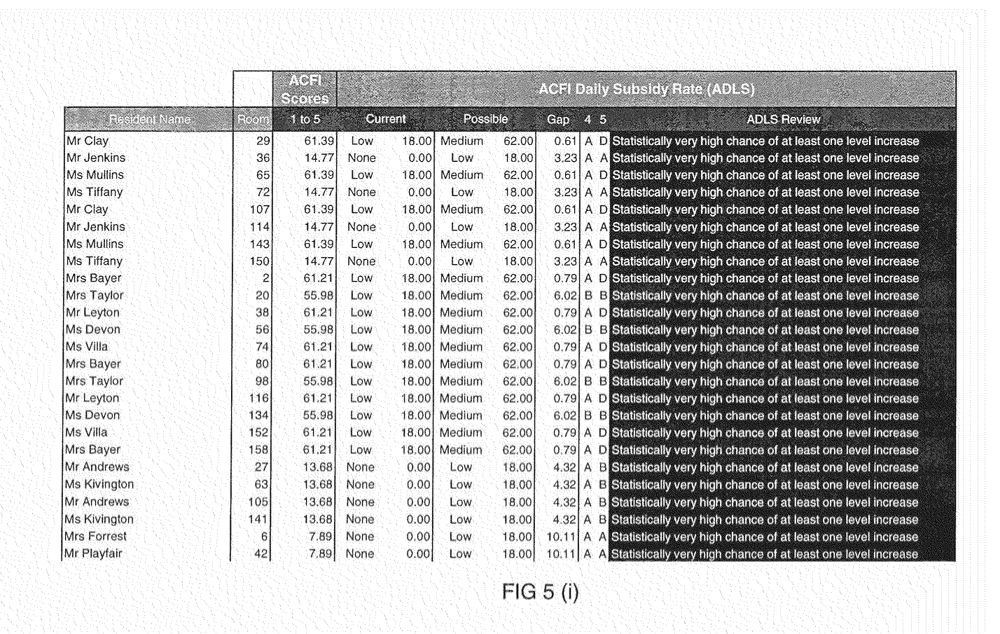

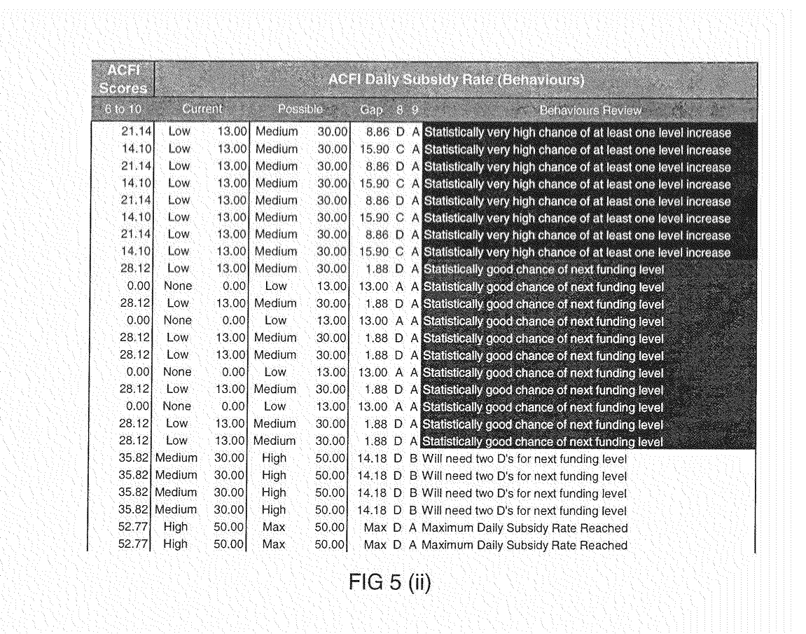

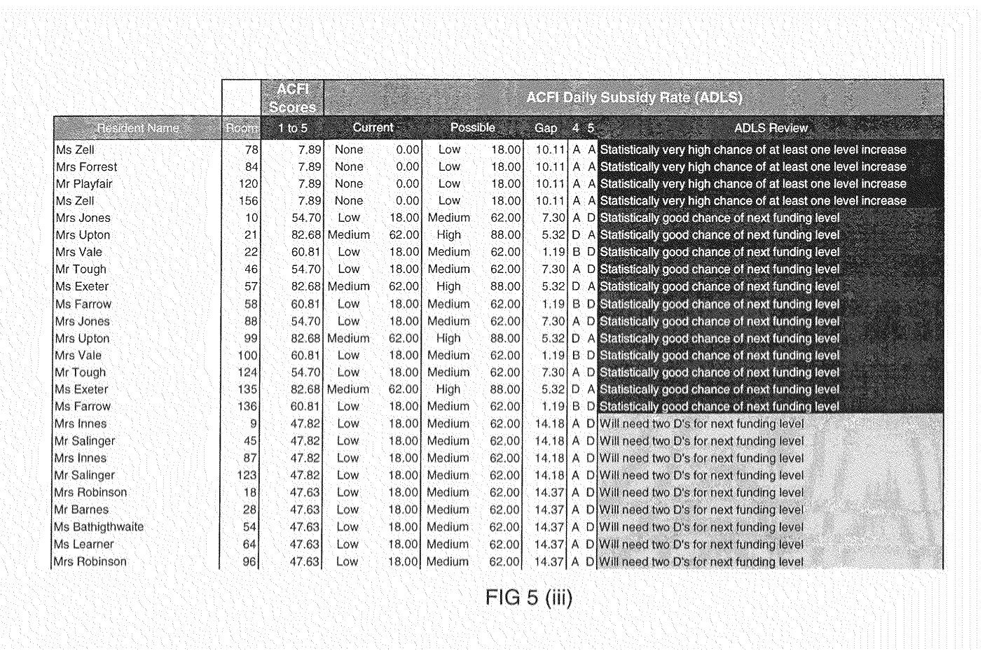

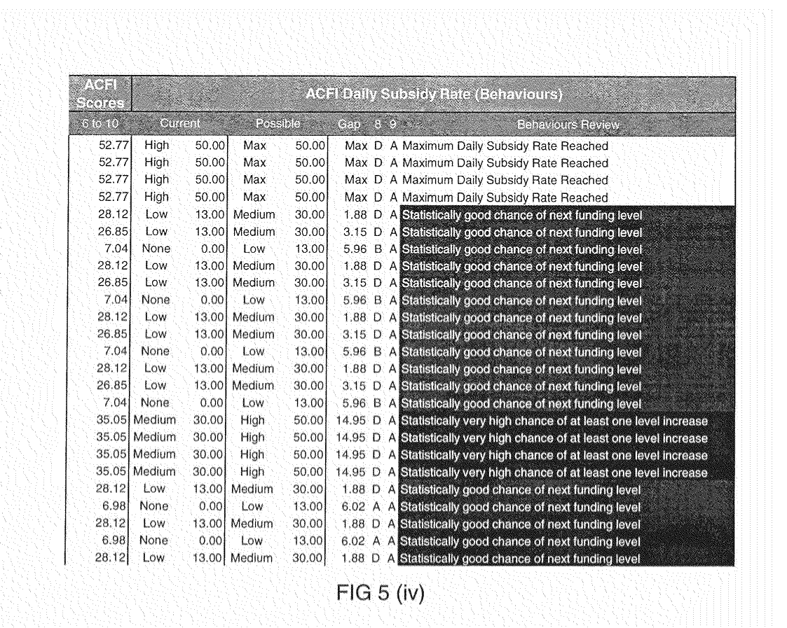

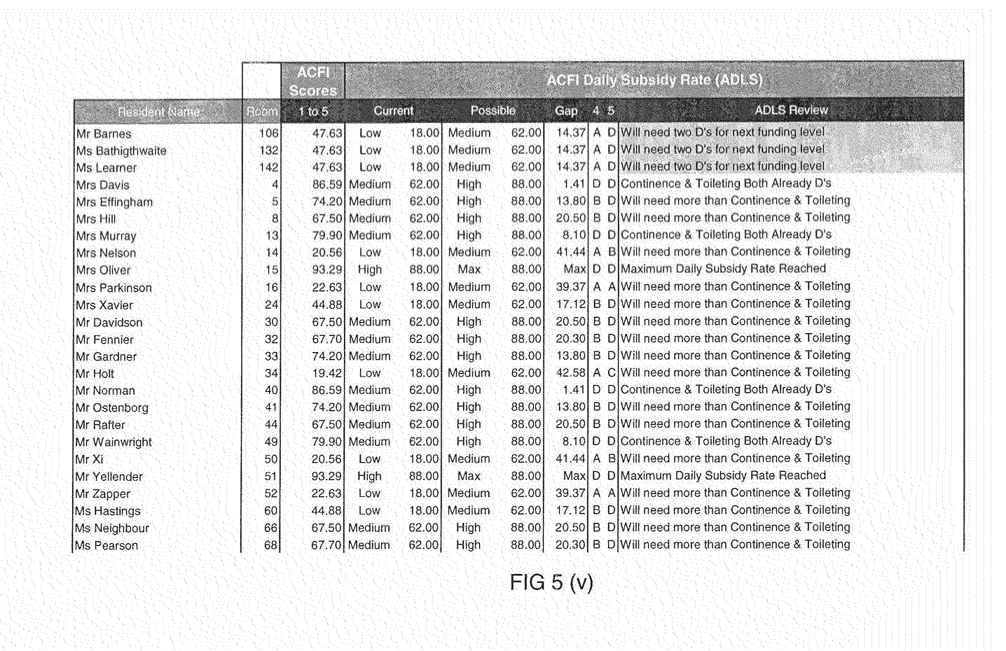

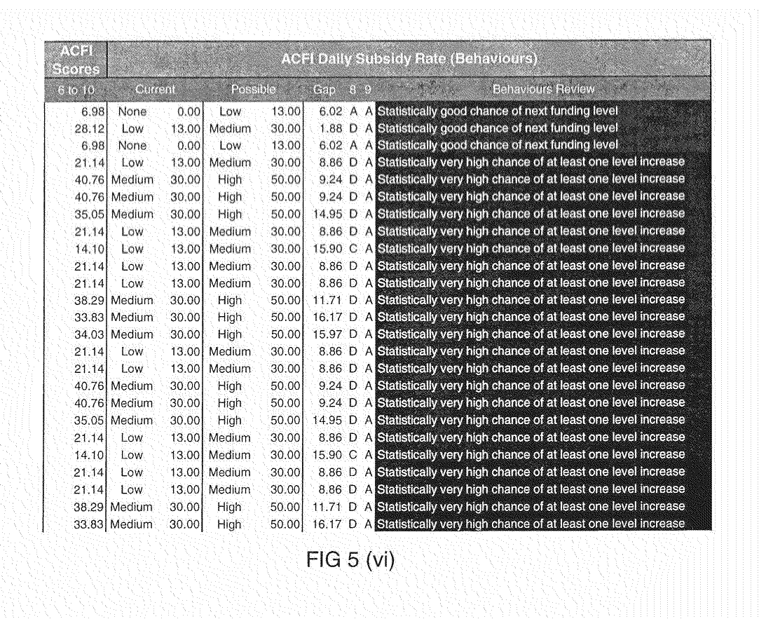

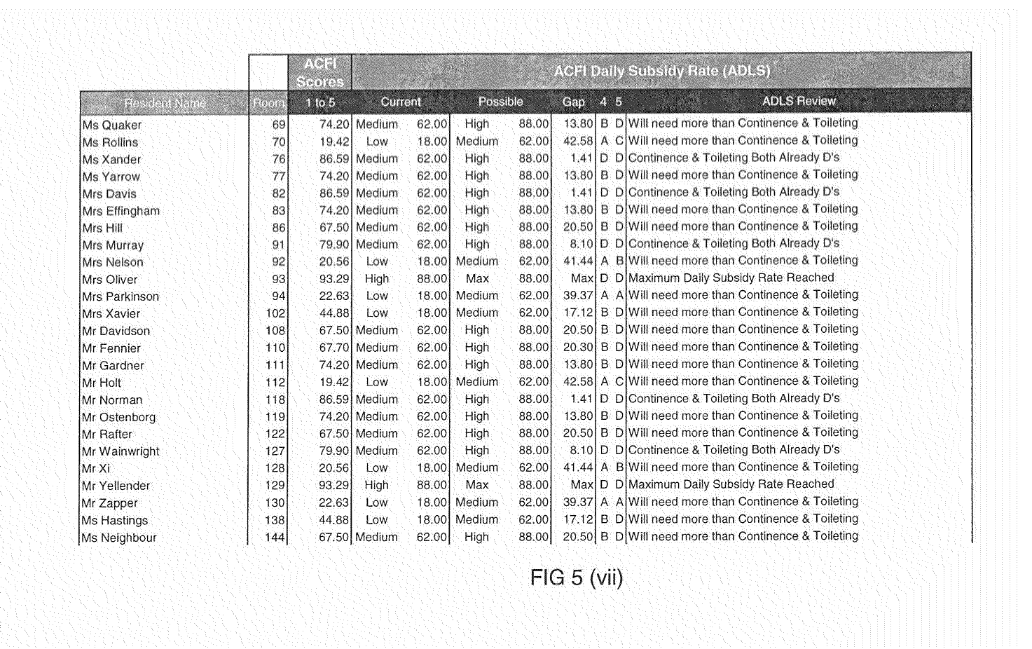

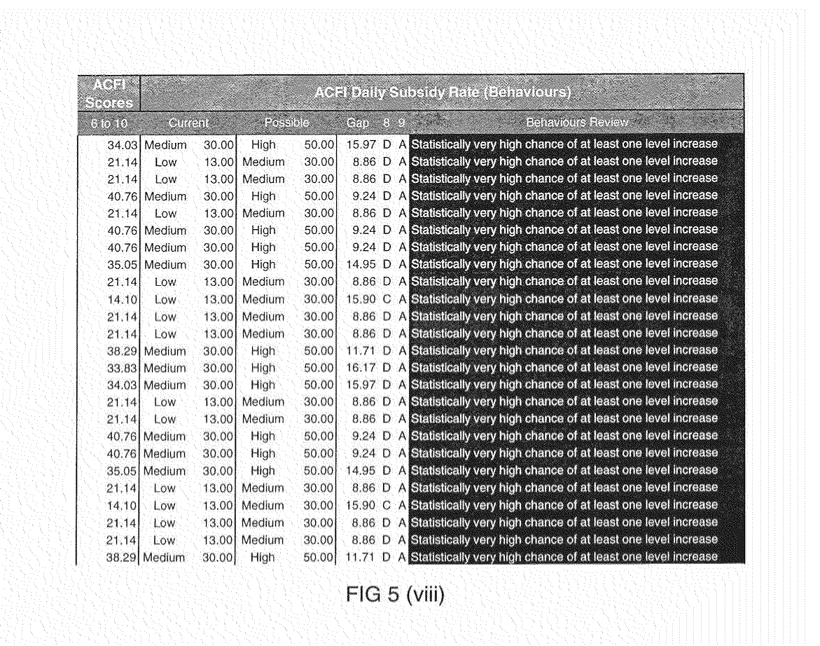

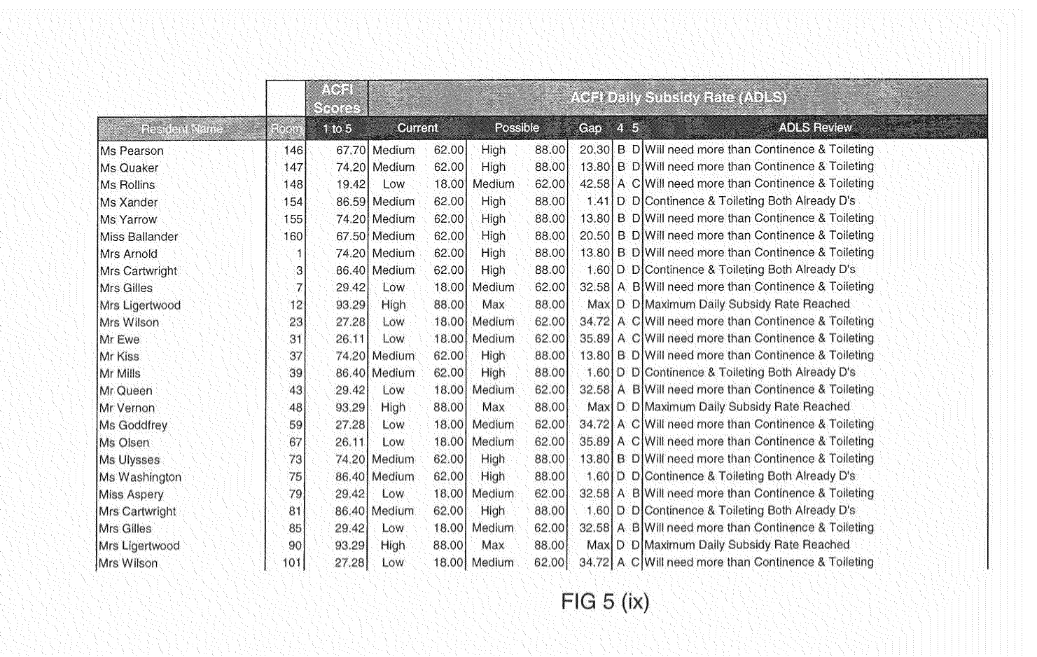

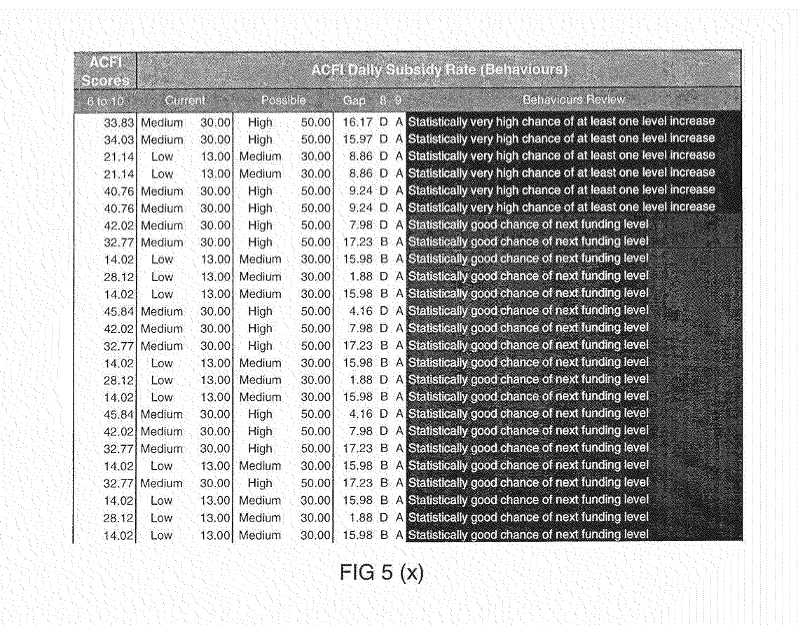

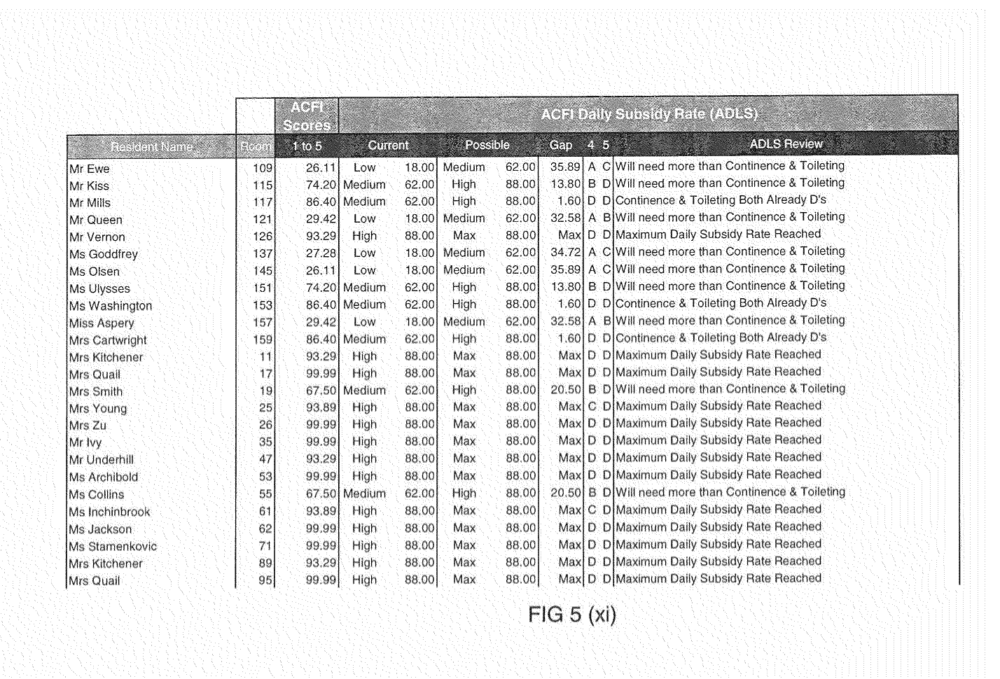

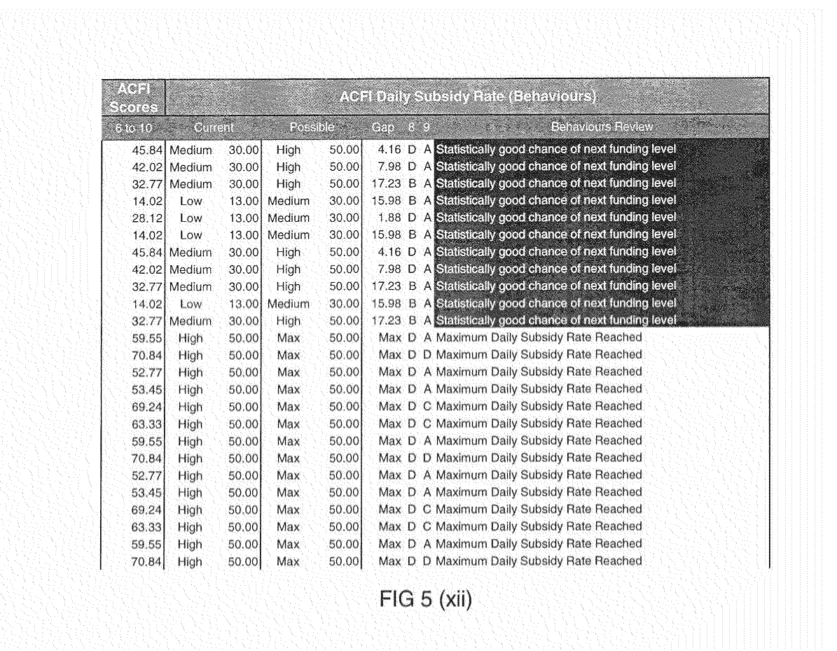

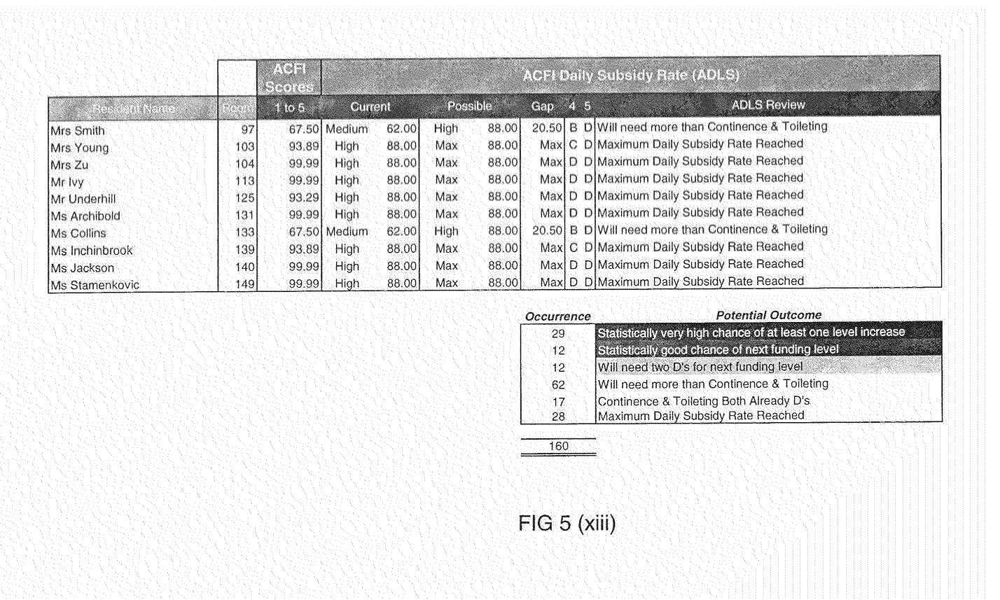

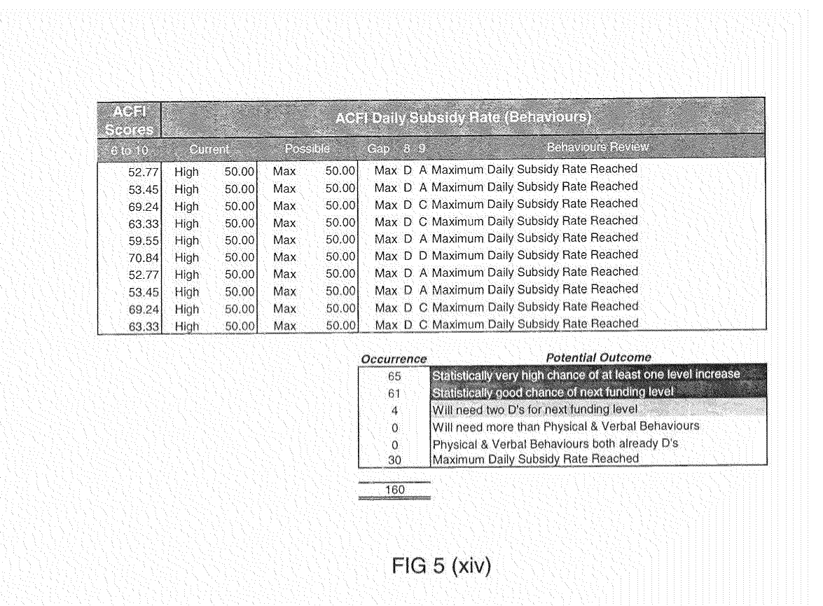

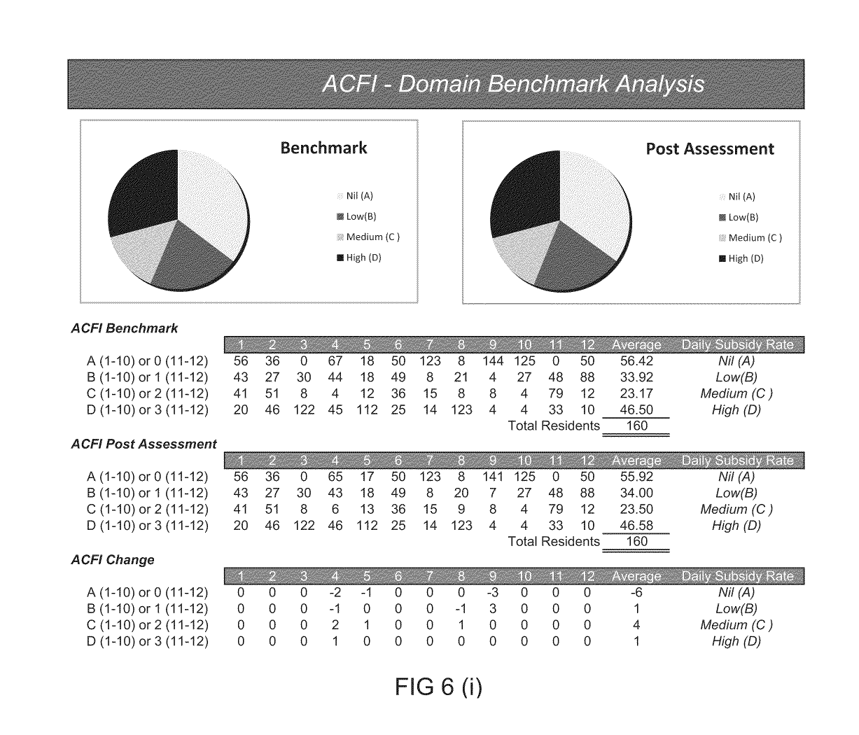

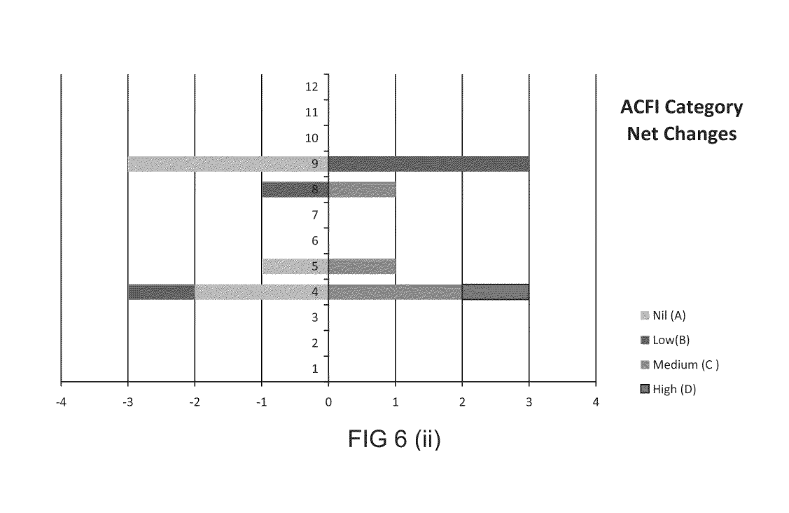

Furthermore, the data processing computer programme also produces an output, as illustrated in FIGS. 5 (i) to 5 (xiv), in which the patients are prioritised in order of the proximity with which one or more of the total values of the patients in the groups of categories of diagnoses are close to an upper limit of the value range containing the value. This output indicates to the care provider which of the patients under the care of the provider have a total value in one of the groups of categories of diagnoses that is close to exceeding the threshold upper limit of the value range containing the value. This indicates to the care provider which of the patients could, upon reassessment of the patient's diagnosis, result in the total value of the patient in one of the groups of categories exceeding the threshold upper limit of the value range containing the value total. This output also indicates, for each patient, which categories of diagnosis are likely, if reassessed, to provide the greatest probability of causing the total value of the patient in one of the groups of categories to exceed a threshold of a lower value range and enter a higher value range.

The data processing computer programme, as illustrated in FIGS. 5 (i) to 5 (xiv), also produces a prioritised list in which the patients are prioritised on the basis of the number of the groups of categories of diagnoses in which the value total of the patient in the respective groups of categories of diagnoses are likely, if one or more of the categories of diagnosis is reassessed, to exceed a threshold upper limit of the value range containing the value. This output is useful for indicating to the care provider which of the patients under the care of the provider is likely, upon re-assessment of the diagnosis of the patient in one or more of the categories of diagnosis, is likely to exceed the most number of threshold upper limits of the value ranges containing the value totals in the groups of categories of diagnosis.

As can be appreciated, the above output from the system 10 helps the care provider to prioritise which of the patients should be reassessed in one or more categories of diagnosis and for which of the categories of diagnosis the patient should be reassessed in order to assist the care provider to manage related care resources and optionally to also increase the probability that the care provider may be entitled to an increase in funding. An advantage of the system 10 to the care provider is that it helps to ensure that the provider manages its resources effectively and is being adequately funded for care actually being provided to the patient by the care provider. At present this may not always be the case because, for example, in existing care facilities it is common for patients to be reassessed in the categories of diagnosis on an ad hoc basis. For example, reassessment of a patient may occur in accordance with a standard schedule in which a patient may not be reassessed more than once or twice annually regardless of the actual severity of the patient's disorder or the level of care provided to the patient at any given time. Reassessment may also occur in circumstances where the extent of the patient's disorders dramatically deteriorates or improves to the extent that the deterioration or improvement comes to the attention of an administrator or other employees of the care provider.

Accordingly, embodiments of the present invention are advantageous in that they enable a care provider to prioritise patients for reassessment in terms of their diagnoses in the various categories of diagnosis provided for under the funding model not only on the basis of a scheduled reassessment programme, or after rapid changes in the severity of the patient's disorders. Another advantage of embodiments of the invention is that patients for whom there is a reasonably high likelihood that the diagnosis of the patient may have exceeded the severity at which the patient care for the patient is being adequately funded can be identified and prioritized for reassessment. This helps the care provider to ensure that funding provided to the care provider more accurately reflects the amount of care actually being provided to patients in real time.

The present invention has resulted from the identification of a need for an improved system for analysing collected patient data for the purpose of efficiently managing the patient diagnosis assessment process. One outcome is that this may lead to increasing the likelihood that patients whose condition has changed and who may be entitled to move to a higher funding level are identified as candidates for re-assessment. Further, the invention may be used to ensure or maximise the likelihood that the funding or reimbursement received by the provider or facility is an accurate reflection of the amount or type of care being provided to patients in accordance with the funding model of the regulator or funding provider.

The embodiments of the system described herein relate to a system applied to a funding model for a patient care provider and to a system that enables the patient care provider to identify patients who are candidates for further assessment primarily on the basis of their likelihood of moving to a higher funding category. However, it is to be appreciated that the present invention may have application to other purposes. For example, the invention may have application in identifying patients that are at risk of moving into different categories of the quantity or type of care to be provided to the patient rather than just identifying those patients that are at risk of moving into a higher funding category. For example, the invention may have application in identifying patients that are at risk of suffering adverse incidents due to the nature and quantity of care being provided to the patient being inappropriate or inadequate for the treating the extent or severity of one or more of the patient's disorders. Another application of the invention is that it may increase the probability that patients being treated by a care provider are being provided with adequate and appropriate care and thereby reduce the likelihood that the care provider may maintain and/or enhance accreditation and/or qualification requirements applied by regulators or funding providers.

The data processing computer programme also includes software for calculating the probability that one or more of the values or value totals for a patient in one category of diagnosis or a group of categories of diagnosis, is likely to exceed one of the limits of the value range containing the value or the value total. The software may contain an algorithm for determining the probability of the above eventuality.

The databases and computer programme also can include software for producing data in relation to the values or value totals of patients under the care of the provider in one category or a group of categories of diagnosis prior to reassessment initiated as a result of the prioritisation of the patient and data post reassessment of the patient initiated as a result of prioritisation of the patient for reassessment by the system 10. This is advantageous in demonstrating the efficacy and value of the system 10 in real time and in an actual care facility and/or clinical environment. This may also be advantageous in providing data for analysis by the care facility operators and/or the funding providers for the purpose of determining the likelihood that at any given time given the assessed diagnoses of the patient's in the care of the provider, if patients are reassessed then this may result in changes in the level of funding provided to the care provider by the funding provider.

As can be appreciated, the present invention has particular use and suitability in relation to the funding model provided under the Aged Care Funding Instrument of the Australian Commonwealth Government as has been described above. However, it can be appreciated that the present invention may be applicable to other purposes than for prioritising patients for reassessment of their diagnosis in a patient care facility and may have broader applicability to uses other than in patient care and aged care facilities and to the operators thereof.

Further, the invention has applicability in a range of funding and care paradigms. These paradigms may have benchmarking or other criteria that can be utilised by the system for analysis of data for patients and other subjects to facilitate their management for assessment in the care environment, in education, and other environments where planning and or/funding criteria are applied. The care, planning and/or funding criteria may be specified for a particular individual according to one or more of e.g. geographical location (e.g. country of residence), an applicable funding source and/or funding instrument, age and the like.

It is to be understood that various modifications, additions, and/or alterations may be made to the parts previously described without departing from the ambit of the present invention as described in the claims appended hereto.

Future patent applications may be filed in the United States or overseas on the basis of or claiming priority from the present application. It is to be understood that the following provisional claims are provided by way of example only and are not intended to limit the scope of what may be claimed in any such future application. Features may be added to or omitted from the provisional claims at a later date so as to further define or re-define the invention or inventions.

1. A system for analyzing patient data in an automated system for managing patient assessment, the system including:
a database for storing patient assessment data collected from a plurality of patients;
a computer processor executing instructions stored in a computer program;
a data processing computer program executed by the computer processor, the program comprising instructions for
identifying one or more patients who have one or more predetermined care requirements
wherein the predetermined care requirement optionally comprises one or more of: further assessment, a predetermined medical or surgical intervention, a funding-related requirement, an incontinence-related requirement, and/or supply of a healthcare product.

2. The system of claim 1, where identification of the one or more patients who have one or more predetermined care requirements optionally comprises one or more of
allocating a value to a patient based on the patient assessment data,
comparing the allocated patient value with a limit value, and/or
assessing proximity of the allocated patient value to a limit of one or more predetermined value ranges containing a patient value.

3. The system of claim 1, wherein the program comprises instructions for prioritizing a plurality of patients who are candidates for further assessment based on the proximity ranking of their respective allocated patient value to a limit of one or more predetermined value ranges containing the patient value.

4. The system of claim 1, wherein patient assessment data is grouped into a plurality of patient assessment categories, and the allocated patient value for each patient is calculated as a sum of sub-values for each of the assessment categories in the group.

5. The system of claim 4, wherein each patient assessment category group includes respectively one of the one or more predetermined value ranges and patients are prioritized based on proximity of the allocated value for each group to the corresponding limit of the one or more predetermined value ranges for the group.

6. The system of claim 1, wherein patients with a patient value in closest proximity to an upper limit of one of the value ranges containing the patient value are highest priority candidates for further assessment.

7. The system of claim 1, wherein the value ranges are consecutive.

8. The system of claim 1, further including calculating a probability that one of the values for a patient will exceed a limit of at least one of the value ranges.

9. The system of claim 8, wherein the patients are prioritized in order of the probability that at least one of the values will exceed a limit of at least one of the value ranges.

10. The system of claim 1, wherein the probability that a patient value will exceed a limit of at least one of the value ranges is determined by gap analysis.

11. The system of claim 1, wherein each of the value ranges corresponds to a quantum of funding for one of the categories of patient assessment.

12. The system of claim 1, wherein the patient assessment data is data that is used to determine a quantum of funding for one of the categories of patient assessment.

13. The system of claim 1, wherein the allocated patient value, the value limit and the value ranges are quantitative.

14. The system of claim 1, wherein the allocated patient value, the value limit and the value ranges are qualitative.

15. The system of claim 1, configurable to operate with one or more benchmarking or other criteria applicable to a funding or care paradigm.

16. The system of claim 15 wherein the funding or care paradigm is based on one or more factors selected from the group including:
(a) geographical location;
(b) funding source;
(c) funding instrument; and
(d) patient age.

17. A computer program comprising instructions for
optionally allocating a value to a patient based on patient assessment data,
optionally comparing the allocated patient value with a limit value and
identifying one or more patients who are candidates for further assessment optionally according to a proximity of the allocated patient value to a limit of one or more predetermined value ranges containing the patient value.

18. A system for managing an aspect of patient care comprising:
a database for storing patient assessment data;
a computer processor to execute instructions stored in a computer program;
a computer program executable by the computer processor, the program comprising instructions for
optionally allocating a value to a patient based on patient assessment data,
optionally comparing an allocated patient value with a limit value and
identifying one or more patients who are candidates for further assessment.

19. A computer program comprising instructions for identifying one or more patients who are candidates for further assessment according to an allocated patient value.

20. A system for managing an aspect of patient care comprising a computer program according to claim 19.
